(19) United States
(12) Patent Application Publication
(10) Pub. No.: US 2026/0021818 A1
(43) Pub. Date: Jan. 22, 2026

(54) STARTUP-RELATED DETERMINATION APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Chuo-ku (JP)

(72) Inventor: Takahiro ISHIKAWA, Tokyo (JP)

(21) Appl. No.: 19/269,969

(22) Filed: Jul. 15, 2025

(30) Foreign Application Priority Data
Jul. 17, 2024 (JP) 2024-114106

(51) Int. Cl. B60W 50/00; B60L 58/12; B60W 40/08; G06V 20/59; G06V 40/16

(52) U.S. Cl. CPC B60W 50/0098; B60L 58/12; B60W 40/08; G06V 20/59; G06V 40/172; B60L 2250/20; B60W 2040/0809; B60W 2050/0083; B60W 2420/403; B60W 2510/244; B60W 2540/043

(57) ABSTRACT

In a startup-related determination apparatus, a battery-state monitor monitors battery information indicative of an operational state of a battery installed in the vehicle when an ignition-on state of the vehicle transitions to an ignition-off state. The battery information is related to an amount of electrical charge in the battery. A storing unit stores the battery information monitored by the battery-state monitor in a nonvolatile memory region. An information acquisition unit acquires, from the nonvolatile memory region, the battery information in response to an occurrence of a power-on startup event for the vehicle. A determiner determines, based on the battery information, whether to permit execution of a predetermined application installed in the vehicle until the ignition-off state of the vehicle transitions to the ignition-on state.

### REFERENCE TO RELATED APPLICATIONS

This application is based on and claims the benefit of priority from Japanese Patent Application No. 2024-114106 filed on Jul. 17, 2024, the disclosure of which is incorporated in its entirety herein by reference.

### TECHNICAL FIELD

The present disclosure relates to startup-related determination apparatuses.

### BACKGROUND

Recent vehicles are each designed to incorporate applications that use images captured by a camera and/or voice collected by a microphone; the camera and microphone are installed in each of the recent vehicles. For example, a technology using a personal authorization application incorporated in a vehicle has been proposed.

When a door of the vehicle is opened, the technology activates a camera to capture an image of a driver of the vehicle, and runs the personal authorization application to perform personal authorization of the driver based on the captured image. When the personal authorization of the driver of the vehicle is successful, the technology automatically adjusts the seat position and mirror positions to predetermined respective settings associated with the authenticated driver.

A camera, a microphone, and applications related to the camera and/or microphone operate on battery power until the vehicle transitions to the ignition-on state even after opening of the door. A long ignition-off period results in continuous consumption of the battery power, resulting in a decrease in the remaining capacity of the battery. From this viewpoint, one example approach is to monitor the remaining capacity of the battery, and control power supply from the battery in accordance with the monitored remaining capacity of the battery.

For example, Japanese Patent Application Publication No. 2018-177131 discloses a power control apparatus equipped with a driver monitor and a controller installed in a vehicle. The driver monitor is configured to monitor the status of a driver, and the controller is configured to control power supply from a power source to the driver monitor. In response to detection of the driver entering the vehicle, the controller starts power supply from the power source to the driver monitor.

Additionally, the controller continues the power supply from the power source to the driver monitor in response to detection of at least one of predetermined operations related to the vehicle for a predetermined period after the start of the power supply from the power source to the driver monitor.

In contrast, the controller shuts off the power supply from the power source to the driver monitor in response to no detection of any predetermined vehicle-related operations for the predetermined period after the start of the power supply.

### SUMMARY

Unfortunately, there has been room for improvement in controlling activation of one or more applications during the period from the startup of the power control apparatus to the transition of the vehicle to the ignition-on state.

In view of the above circumstances, the present disclosure seeks to provide startup-related determination apparatuses, each of which is capable of determining, based on a remaining capacity of a battery, whether to permit execution of at least one application to appropriately control the remaining capacity of the battery.

An exemplary aspect of the present disclosure provides a startup-related determination apparatus for a vehicle. The startup-related determination apparatus includes a battery-state monitor configured to monitor operational information on a battery installed in the vehicle when an ignition-on state of the vehicle transitions to an ignition-off state. The operational information on the battery is related to an amount of electrical charge in the battery. The startup-related determination apparatus includes a storing unit configured to store the operational information on the battery monitored by the battery-state monitor in a nonvolatile memory region. The startup-related determination apparatus includes an information acquisition unit configured to acquire, from the nonvolatile memory region, the operational information on the battery in response to an occurrence of a power-on startup event for the vehicle. The startup-related determination apparatus includes a determiner configured to determine, based on the acquired operational information on the battery, whether to permit execution of a predetermined application installed in the vehicle until the ignition-off state of the vehicle transitions to the ignition-on state.

This configuration of the startup-related determination apparatus makes it possible to determine, based on the operational information on the battery, whether to permit execution of the predetermined application during a period of the ignition-off state of the vehicle for which charging of the battery is difficult. Additionally, because the operational information on the battery has been already stored at the transition of the ignition-on state to the ignition-off state, it is possible to eliminate the need of newly monitoring the operational information on the battery at a time of current entry to the vehicle.

This therefore provides the startup-related determination apparatus, which is capable of more appropriately controlling the operational state of the battery and determining whether to permit execution of the predetermined application earlier than in a case where the operational state of the battery is newly monitored at the time of current entry to the vehicle.

### BRIEF DESCRIPTION OF THE DRAWINGS

The above object, other objects, characteristics, and advantageous benefits of the present disclosure will become apparent from the following description with reference to the accompanying drawings in which:

FIG. 1 is a block diagram schematically illustrating an example of a configuration of a startup-related determination system according to the first embodiment;

FIG. 2 is a table schematically illustrating a first example of four combination patterns among (i) battery information to be stored in the battery, (ii) whether to permit activation and/or execution of a target application, and (iii) whether to permit power supply to information acquisition/support devices according to the first embodiment;

FIG. 3 is a table schematically illustrating a second example of four combination patterns among (i) the battery information to be stored in the battery, (ii) whether to permit activation and/or execution of the target application, and (iii) whether to permit power supply to the information acquisition/support devices according to the first embodiment;

FIG. 4 is a flowchart schematically illustrating an ignition-off related routine according to the first embodiment;

FIG. 5 is a flowchart schematically illustrating a startup-related determination routine according to the first embodiment;

FIG. 6 is a flowchart schematically illustrating a personal authorization subroutine in step S118 of the startup-related determination routine;

FIG. 7 is a flowchart schematically illustrating an ignition-on related routine according to the first embodiment;

FIG. 8 is a table schematically illustrating an example of two combination patterns among (i) the battery information to be stored in the battery, (ii) whether to permit activation and/or execution of the target application, and (iii) whether to permit power supply to the information acquisition/support devices according to the first modification of the first embodiment;

FIG. 9 is a table schematically illustrating an example of two combination patterns among (i) the battery information to be stored in the battery, (ii) whether to permit activation and/or execution of the target application, and (iii) whether to permit power supply to the information acquisition/support devices according to the second modification of the first embodiment;

FIG. 10 is a table schematically illustrating an example of six combination patterns among (i) the battery information to be stored in the battery, (ii) whether to permit activation and/or execution of the target application, and (iii) whether to permit power supply to the information acquisition/support devices according to the third modification of the first embodiment;

FIG. 11 is a flowchart schematically illustrating a startup-related determination routine according to the second embodiment;

FIG. 12 is a flowchart schematically illustrating an ignition-on related routine according to the second embodiment;

FIG. 13 is a flowchart schematically illustrating a startup-related determination routine according to the third embodiment; and

FIG. 14 is a flowchart schematically illustrating an ignition-on related routine according to the third embodiment.

### DETAILED DESCRIPTION OF EMBODIMENT

The following describes startup-related determination systems 1 according to exemplary embodiments of the present disclosure with reference to accompanying drawings. In the following exemplary embodiments, substantially identical components are represented by the same reference characters and redundant explanations are omitted.

### First Embodiment

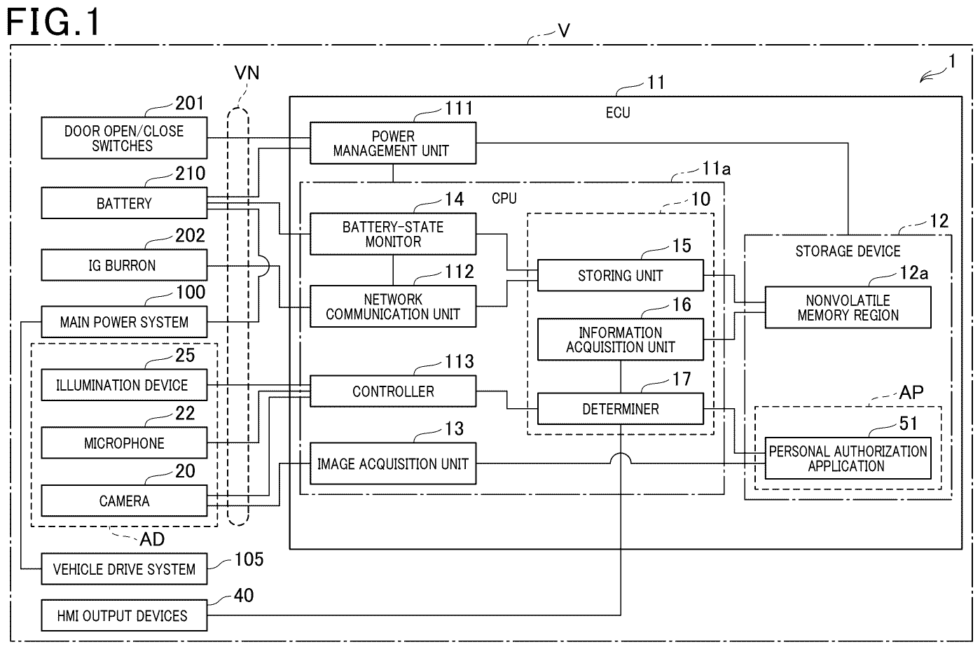

The following describes the first embodiment with reference to FIGS. 1 to 10. The startup-related determination system 1 according to the first embodiment is installed in, for example, a vehicle V.

The startup-related determination system 1 includes, for example, an electronic control unit (ECU) 11 serving as a control device for the vehicle V. The ECU 11 includes a Central Processing Unit (CPU) 11a, a storage device 12, and a power management unit 111. The startup-related determination system 1 includes a battery 210 as a power source of the vehicle V and one or more applications AP stored in the storage device 12.

The ECU 11 of the startup-related determination system 1 is configured to perform a startup-related determination routine at power-on startup thereof in accordance with the operational state of the battery 210, such as the State of Charge (SOC) thereof.

The startup-related determination routine is designed to determine, for a period from the start of power to the ECU 11 to the transition of the vehicle V to the ignition-on state, whether to permit activation and/or execution of a target application included in the applications AP based on the operational state of the battery 210.

Additionally, the startup-related determination routine is designed to determine whether to permit, based on the operational state of the battery 210, power supply to a selected at least one device included in information acquisition/support devices AD installed in the vehicle V; the selected at least one device included n the information acquisition/support devices AD acquires information used by the target application and/or supports acquisition of the information used by the target application.

The determination of whether to permit activation and/or execution of a target application will also be referred to as an application determination, and the determination of whether to permit power supply to the information acquisition devices will also be referred to as a power supply determination.

In particular, the ECU 11 of the startup-related determination system 1 is configured to perform the application determination and the power supply determination using battery information representing the operational state of the battery 210 at the last ignition-off timing, i.e., at the time of last exit from the vehicle V without using information on the operational state of the battery 210 at the power-on startup of the ECU 11.

Specifically, the ECU 11 of the startup-related determination system 1 is configured to approximate the operational state of the battery 210 at the time of current entry to the vehicle V by the operational state of the battery 210 at the time of last exit from the vehicle V assuming that change in the operational state of the battery 210 between the time of last exit from the vehicle V to the time of current entry to the vehicle V, so that the operational state of the battery 210 at the time of current entry to the vehicle V is substantially identical to the operational state of the battery 210 at the time of last exit from the vehicle V. In more detail, the ECU 11 of the startup-related determination system 1 is configured to store the battery information at the time of last exit from the vehicle V in a nonvolatile memory region 12a included in the storage device 12, and read out the battery information stored in the nonvolatile memory at the time of current entry to the vehicle V.

This configuration of the ECU 11 of the startup-related determination system 1 makes it possible to perform the application determination and the power supply determination faster as compared with a case where the ECU 11 newly detects the battery information at the time of current entry to the vehicle V.

Referring to FIG. 1, the startup-related determination system 1 additionally includes the information acquisition/support devices AD, Human-Machine Interface (HMI) output devices 40, door open/close switches 201, and an ignition (IG) button 202. The information acquisition/support devices AD include, for example, a camera 20, a microphone 22, and an illumination device 25 for the camera 20. The camera 20 and the illumination device 25 constitute a camera system.

The ECU 11 is, for example, configured to control various electronic devices installed in the vehicle V. The ECU 11 is communicably connected to, for example, the door open/close switches 201, the IG button 202, the camera 20, the microphone 22, the illumination device 25, and the HMI output devices 40. For example, the communications between the ECU 11 and the various devices 201, 202, 20, 22, 25, and 40 can be performed through an in-vehicle network, such as a Controller Area Network, VN.

In the startup-related system 1 illustrated in FIG. 1, the lines connecting the components do not necessarily represent physical lines, but may include lines indicating communicability or electrical connections. Furthermore, the lines between functional components within the ECU 11 represent the relationships between those functional components.

The camera 20 includes, for example, a lens system and an image sensor, such as a complementary metal oxide (CMOS) image sensor or a charge-coupled device (CCD) image sensor.

The illumination device 25 is comprised of, for example, a light-emitting diode (LED) as its light source, and is configured to illuminate, based on light emitted from the LED light source, a target inside the vehicle V to be captured by the camera 20. The target to be captured includes, for example, the face of the driver or the upper half of the body of the driver.

The camera 20 is configured to capture images, i.e., frame images, of the target while the illumination device 25 illuminates the target using a controllable gain. This enables the camera 20 to capture clear images of the target; each frame image is comprised of two-dimensionally arranged pixels corresponding to a two-dimensionally arranged light-sensitive elements of the image sensor. For each frame image, an exposure time, i.e., a shutter time or a shutter speed, of the light-sensitive elements of the image sensor of the camera 20 is controlled to determine the frame rate of the camera 20. The controllable gain is used to amplify the respective pixels, i.e., the pixel values or intensity levels of the respective pixels, of each frame image.

The microphone 22 is configured to convert sound waves emitted by the occupants of the vehicle V into electric information; the electric information based on the sound waves can be used to be recorded in, for example, the storage device 12 and/or used for the applications AP.

Each of the HMI output devices 40 is configured to provide information to the occupants and feedback therefrom through visual, auditory, and/or other sensory means. For example, the HMI output devices 40 include various meters, in-vehicle infotainments, and/or speakers.

The storage device 12 is comprised of, for example, one or more read-only memories (ROMs), one or more random access memories (RAMs), and/or flash memories. One of the ROMs and/or flash memories serves as the nonvolatile memory region 12a. The storage device 12 stores computer programs, i.e., computer-program instructions, that cause the CPU 11a to perform various routines and/or various tasks. The battery information can be stored in the nonvolatile memory region 12a. The nonvolatile memory region 12a can be installed in a server provided outside the vehicle V, so that the CPU 11a of the ECU 11 can communicate with the nonvolatile memory region 12a through an external network, such as the internet. If the nonvolatile memory region 12a can be installed in the server, the startup-related determination system 1 can include a communication unit through which the CPU 11a of the ECU 11 communicates with the server.

The battery 210 is configured to supply power to, for example, each of the ECU 11, the door open/close switches 201, the IG button 202, the camera 20, the illumination device 25, the microphone 22, and the HMI output devices 40. The battery 210 is configured to be chargeable by an unillustrated power generator, such as an unillustrated alternator, installed in the vehicle V during the vehicle V being in the ignition-on state. During the vehicle V being in the ignition-off state, the power generator cannot charge the battery 210, so that the battery 210 is not charged.

The vehicle V includes a main power system 100 and a vehicle drive system 105, such as a power-train ECU, an engine drive system, and/or a motor drive system, connected to the main power system 100.

The CPU 11a of the ECU 11 includes, for example, a network communication unit 112, a controller 113, an image acquisition unit 13, and a battery-state monitor 14.

Each of the door open/close switches 201 is provided for the corresponding one of the doors of the vehicle V. Each door open/close switch 201 is connected to the power management unit 111. Each door open/close switch 201 is configured to output a door open signal to the power management unit 111 upon the corresponding door is opened. The power management unit 111 is connected to the battery 210. The power management unit 111 is configured to wake up in an active mode, i.e., an ON mode, from a sleep mode, i.e., an OFF mode, in response to the occurrence of opening of a door of the vehicle V, i.e., the occurrence of the door open signal, as a power-on startup event from one of the door open/close switches 201, so that the ECU 11 is in a power-on state. That is, the power management unit 111 is configured to supply, to each component of the ECU 11, operating power acquired based on the power supplied from the battery 210, thus activating each component of the ECU 11 in the power-on state of the ECU 11.

In contrast, the power management unit 111 is configured to transition from the active mode to the sleep mode in response to determination that a power-off signal for the ECU 11 is generated from, for example, the door open/close switches 201 during the ignition-off state. That is, the power-off signal for the ECU 11 is generated when all the door open/close switches 201 have detected corresponding door locks.

The ignition button 202 is configured to output an ignition ON signal to the ECU 11, i.e., the network communication unit 112, in response to the driver's operation of the ignition button 202 during one or more predetermined vehicle-start conditions being satisfied. In response to receiving the ignition ON signal, the ECU 11 instructs the main power system 100 to supply, based on the power supplied from the battery 210, drive power to the vehicle drive system 105, thus activating the vehicle drive system 105. This results in the vehicle V transitioning to the ignition-on state.

The term “ignition-on state” as used in this specification broadly denotes the state of a vehicle in which a main power supply system is activated, such that various control units of the vehicle become operable, and the vehicle is ready for engine start and/or motor start, irrespective of whether an engine (if present) and/or a motor (if present) are actually started.

In contrast, the ignition button 202 is configured to output an ignition OFF signal to the ECU 11, i.e., the network communication unit 112, in response to the driver's operation of the ignition button 202 during one or more predetermined vehicle-stop conditions being satisfied.

In response to receiving the ignition OFF signal, the ECU 11 instructs the main power system 100 to shut off the supply of the drive power to the vehicle drive system 105, thus deactivating the vehicle drive system 105. This results in the vehicle V transitioning to the ignition-off state.

The term “ignition-off state” as used in this specification broadly denotes the state of a vehicle in which the main power supply system is deactivated, such that the various control units of the vehicle become inoperable, and the vehicle is not ready for engine start and/or motor start.

That is, the ECU 11 can be configured to change the vehicle V between the ignition-on mode and the ignition-off mode.

The network communication unit 112 is configured to communicate with the various devices 201, 202, 20, 22, 25, and 40 through the in-vehicle network VN to detect an operation of the ignition button 202.

The controller 113 is configured to control operations of the camera system comprised of the camera 20 and the illumination device 25. The controller 113 is additionally configured to control operations of the microphone 22.

The battery-state monitor 14 is configured to continuously monitor the battery information representing the operational state of the battery 210 during the ignition-on state of the vehicle V. The battery-state monitor 14 can be configured to monitor, every predetermined period, the battery information representing the operational state of the battery 210 during the ignition-on state of the vehicle V.

The battery information includes, for example, at least one of the remaining SOC or the remaining charge level of the battery 210, the maximum capacity, which represents the maximum SOC, of the battery 210, and the specification information on the battery 210. The battery information is, however, not limited to the above information items.

Specifically, the battery information according to the first embodiment includes both the remaining SOC of the battery 210 and the maximum capacity of the battery 210. The battery information according to at least one of the other embodiments may include the remaining capacity of the battery 210, and the battery information according to at least one of the other embodiments may include the maximum capacity of the battery 210. The battery information according to at least one of the other embodiments may include the specification information on the battery 210.

The specification information on the battery 210 may include one or more various specifications of the battery 210, such as the rated capacity of the battery 210. In this specification, the rated capacity of the battery 210 refers to the absolute amount of electric charge that can be extracted from the battery 210 under specified conditions, such as a new-product condition under which the battery 210 is fully charged. The maximum capacity of the battery 210 refers to a value that gradually decreases with repeated charging and discharging assuming that the fully charged state of the new battery 210 is set to 100%, and represents a relative percentage with respect to the rated capacity. The remaining capacity of the battery 210 indicates the amount of electric charge that can be extracted from the battery 210 at any point in time. The remaining capacity of the battery 210 may be expressed either as an absolute value or as a relative percentage with respect to the rated capacity or the maximum capacity.

The controller 113 is configured to control image-capture conditions of the camera system to control the distribution of the pixel levels of a face region of the target, i.e., the driver, included in a captured image, who changes moment by moment. This enables the camera system to capture frame images of the face of the driver of the vehicle V with a high contrast level. For example, the controller 113 is configured to control at least one of the exposure time of a frame image to be captured by the camera 20, a value of the gain, and the amount of light emitted by the illumination device 25.

The camera 20, the illumination device 25, and the microphone 22, which are connected to the ECU 11 through the in-vehicle network NW according to the first embodiment, may be connected to the ECU 11 through respective dedicated communication lines.

The applications AP are application programs usable by occupants in the vehicle V, which include, for example, applications previously installed in the vehicle V and/or applications installed in an unillustrated external device carried in the vehicle V by an occupant and used in the vehicle V. For example, the applications AP include, as the target application, a personal authorization application that uses the measured personal information on a driver of the vehicle V for personal authorization, and an application for detecting items left behind in the vehicle V.

The target application selected from the applications AP is the personal authorization application, which is assigned with reference numeral 51.

The personal information acquired from the driver in real time by at least one of the information acquisition/support devices AD may include, but is not limited to, (i) images including the user's appearance in a form identifiable by, for example, image recognition, (ii) audio containing the user's voice in a form identifiable by, for example, voiceprint recognition, and (iii) image information including, for example, biometric features such as fingerprints, palmprints, palm vein patterns, finger vein patterns, or irises.

The information acquisition/support devices AD may include, in addition to the camera 20 and the microphone 22, a fingerprint sensor, a vein pattern sensor, and other sensors for measuring information usable by at least one of the applications AP.

As the personal information used by the personal authorization application 51 according to the first embodiment, images of the face of the driver captured by the camera 20 are used. The applications AP including the target application may not be installed in the vehicle V. Specifically, the applications AP may be installed in an external device communicable with the ECU 11 of the vehicle V.

The nonvolatile memory region 12a stores pre-registered personal information items on one or more users who are registered to use the vehicle V; the pre-registered personal information items are used to be matched with the personal information acquired from the driver in real time by at least one of the information acquisition/support devices AD. The pre-registered personal information items may include, but are not limited to, (i) images including the faces of the registered users, (ii) the voiceprints of the registered users, (iii) the irises of the registered users, (iv) the fingerprints of the registered users, (v) the palmprints of the registered users, (vi) the vein patterns of the registered uses, and the other individually unique features of the registered uses. As the pre-registered personal information items according to the first embodiment, registered images, each of which includes the face of at least one of the registered users, is used.

Specifically, each time the personal information on a driver acquired from the driver by at least one of the information acquisition/support devices AD, the personal authorization application 51 causes a processor, such as the CPU 11a, to retrieve the pre-registered personal information items from the nonvolatile memory region 12a, and match the acquired personal information with the pre-registered personal information items to accordingly determine whether the personal authorization of the driver is successful.

In detail, each time the personal information on a driver acquired from the driver by at least one of the information acquisition/support devices AD, the personal authorization application 51 causes a processor, such as the CPU 11a, to calculate the degree of matching, i.e., matching score or similarity score, of the acquired personal information with each of the pre-registered personal information items. Then, the personal authorization application 51 causes a processor, such as the CPU 11a, to determine whether the matching score of the acquired personal information with at least one of the pre-registered personal information items is higher than or equal to a predetermined matching threshold. In response to determination that the matching score of the acquired personal information with at least one of the pre-registered personal information items is higher than or equal to the predetermined matching threshold, the personal authorization application 51 causes a processor, such as the CPU 11a, to determine that the personal authorization of the driver is successful. Otherwise, in response to determination that the matching score of the acquired personal information with each of the pre-registered personal information items is lower than the predetermined matching threshold, the personal authorization application 51 causes a processor, such as the CPU 11a, to determine that the personal authorization of the driver is unsuccessful. One of various known calculation methods for calculating the matching score of the acquired personal information with each of the pre-registered personal information items can be used.

In response to determination that the personal authorization of the driver is successful, the authorization application 51 causes a processor, such as the CPU 11a, to output, to at least one of the HMI output devices 40, information indicative of the personal authorization of the driver is successful. In contrast, in response to determination that the personal authorization of the driver is unsuccessful, the authorization application 51 causes a processor, such as the CPU 11a, to output, to at least one of the HMI output devices 40, information indicative of the personal authorization of the driver is unsuccessful. The information outputted from the CPU 11a to at least one of the HMI output devices 40 may instruct the at least one of the HMI output devices 40, such as one of indicator lamps, to illuminate in the successful pattern or the unsuccessful pattern. Alternatively, the information outputted from the CPU 11a to at least one of the HMI output devices 40 may instruct the at least one of the HMI output devices 40, such as one of display devise, to display a message representing that “PERSONAL AUTHORIZATION OF DRIVER IS SUCCESSFUL (UNSUCCESSFUL)”. The information outputted from the CPU 11a to at least one of the HMI output devices 40 may instruct the at least one of the HMI output devices 40, such as a speaker, to output voice or alarm sound indicative of the personal authorization of the driver being successful or unsuccessful.

The ECU 11 additionally includes a startup-related determination module 10 mounted on, for example, the same circuit board of the ECU 11. The startup-related determination module 10 includes, for example, a storing unit 15, an information acquisition unit 16, and a determiner 17.

The storing unit 15 is configured to read, in response to the network communication unit 112 detecting the operation of the ignition button 202 for transition of the vehicle V from the ignition-on state to the ignition-off state, the battery information monitored by the battery-state monitor 14 at the detection timing, and store the battery information in the nonvolatile memory region 12a of the storage device 12. Specifically, the storing unit 15 is configured to store, in the nonvolatile memory region 12a of the storage device 12, the battery information indicative of the operational state of the battery 210 immediately before the time of the driver's exit from the vehicle V.

The storing unit 15 may be configured to store, every predetermined period, such as 1 minute, the battery information monitored by the battery-state monitor 14. In this modification, the storing unit 15 may be configured to rewrite the previously stored battery information in the nonvolatile memory region 12a into newly monitored battery information.

This results in, in response to transition of the vehicle V from the ignition-on state to the ignition-off state, the battery information written by the storing unit 15 immediately before the transition of the vehicle V from the ignition-on state to the ignition-off state being stored in the nonvolatile memory region 12a. This therefore enables, in this modification, the battery information, which is substantially identical to the battery information immediately before the driver's exit from the vehicle V, being stored in the nonvolatile memory region 12a.

The information acquisition unit 16 is configured to acquire, when the power management unit 111 waking up in the active mode in response to detection of door opening of the vehicle V, i.e., in response to detection of the occurrence of the power-on startup event for the vehicle V, the battery information stored in the nonvolatile memory region 12a at the timing of transition of the vehicle V from the ignition-on state to the ignition-off state. That is, the information acquisition unit 16 is configured to acquire, from the nonvolatile memory region 12a, the battery information monitored immediately before the driver's last exit from the vehicle V. While no users, i.e., no occupants, are in the vehicle V, it is possible to estimate that the battery 210 does not consume power or, even if the battery 210 consumes power, the consumed amount of power is typically negligible. For this reason, the remaining capacity or the maximum capacity of the battery 210 immediately before the driver's last exit from the vehicle V can be approximately regarded as the remaining capacity or the maximum capacity of the battery 210 at the time of driver's current entry to the vehicle V.

The determiner 17 is configured to perform the startup-related determination routine. The startup-related determination routine includes a first determination task of determining whether to permit activation and/or execution of the target application 51. The startup-related determination routine includes a second determination task of determining whether to permit power supply to a selected at least one device included in the information acquisition/support devices AD; the selected at least one device in the information acquisition/support devices AD acquires information used by the target application 51.

In particular, the determiner 17 is configured to determine not to permit activation and/or execution of the target application 51 and not to permit power supply to the selected at least one device in response to determination that the battery information represents that the battery 210 is in a recharge-required state; this negative determination works to reduce power consumption of the battery 210. The recharge-required state of the battery 210 in this specification represents the amount of electrical charge in the battery 210 being lower than a predetermined electrical-charge amount.

The recharge-required state of the battery 210 can be defined using the remaining capacity of the battery 210, the maximum capacity of the battery 210, the rated capacity of the battery 210, or any combination of the remaining capacity, the maximum capacity, and the rated capacity of the battery 210. That is, the battery 210 is determined to be in the recharge-required state when (i) a first condition that the remaining capacity of the battery 210 is lower than a predetermined first threshold is satisfied, (ii) a second condition that the maximum capacity of the battery 210 is lower than a predetermined second threshold is satisfied, (iii) a third condition that the rated capacity of the battery 210 is lower than a predetermined third threshold is satisfied, or any combination of the first to third conditions is satisfied.

As a first case, the battery 210 is determined to be in the recharge-required state when the first condition that the remaining capacity of the battery 210 is lower than the predetermined first threshold is satisfied. As a second case, the battery 210 is determined to be in the recharge-required state when the second condition that the maximum capacity of the battery 210 is lower than the predetermined second threshold is satisfied. As a third case, the battery 210 is determined to be in the recharge-required state when the third condition that the rated capacity of the battery 210 is lower than the predetermined third threshold is satisfied.

As a fourth case, the battery 210 is determined to be in the recharge-required state when both the first and second conditions are satisfied. As a fifth case, the battery 210 is determined to be in the recharge-required state when both the first and third conditions are satisfied. As a fifth case, the battery 210 is determined to be in the recharge-required state when both the second and third conditions are satisfied.

As a sixth case, the battery 210 is determined to be in the recharge-required state when (i) the first condition that the remaining capacity of the battery 210 is lower than the predetermined first threshold is satisfied and (ii) the second condition is not satisfied, that is, the maximum capacity of the battery 210 is higher than or equal to the predetermined second threshold. As a seventh case, the battery 210 is determined to be in the recharge-required state when (i) the first condition is not satisfied, that is, the remaining capacity of the battery 210 is higher than or equal to the predetermined first threshold, and (ii) the second condition that the maximum capacity of the battery 210 is lower than the predetermined second threshold is satisfied.

As an eighth case, the battery 210 is determined to be in the recharge-required state when (i) the first condition that the remaining capacity of the battery 210 is lower than the predetermined first threshold is satisfied, and (ii) the third condition is not satisfied, that is, the rated capacity of the battery 210 is higher than or equal to the predetermined third threshold. As a ninth case, the battery 210 is determined to be in the recharge-required state when (i) the first condition is not satisfied, that is, the remaining capacity of the battery 210 is higher than or equal to the predetermined first threshold, and (ii) the third condition that the rated capacity of the battery 210 is lower than the predetermined second threshold is satisfied.

As a tenth case, the battery 210 is determined to be in the recharge-required state when (i) the second condition that the maximum capacity of the battery 210 is lower than the predetermined second threshold is satisfied and (ii) the third condition is not satisfied, that is, the rated capacity of the battery 210 is higher than or equal to the predetermined third threshold.

As an eleventh case, the battery 210 is determined to be in the recharge-required state when (i) the second condition is not satisfied, that is, the rated capacity of the battery 210 is higher than or equal to the predetermined third threshold, and (ii) the third condition that the rated capacity of the battery 210 is lower than the predetermined third threshold is satisfied.

As a twelfth case, the battery 210 is determined to be in the recharge-required state when (i) the first condition that the remaining capacity of the battery 210 is lower than the predetermined first threshold is satisfied, (ii) the second condition that the maximum capacity of the battery 210 is lower than the predetermined second threshold is satisfied, and (iii) the third condition that the rated capacity of the battery 210 is lower than the predetermined third threshold is satisfied.

As a thirteenth case, the battery 210 is determined to be in the recharge-required state when (i) the first condition that the remaining capacity of the battery 210 is lower than the predetermined first threshold is satisfied, (ii) the second condition that the maximum capacity of the battery 210 is lower than the predetermined second threshold is satisfied, and (iii) the third condition is not satisfied, that is, the rated capacity of the battery 210 is higher than or equal to the predetermined third threshold.

As a fourteenth case, the battery 210 is determined to be in the recharge-required state when (i) the first condition that the remaining capacity of the battery 210 is lower than the predetermined first threshold is satisfied, (ii) the second condition is not satisfied, that is, the maximum capacity of the battery 210 is higher than or equal to the predetermined second threshold, and (iii) the third condition that the rated capacity of the battery 210 is lower than the predetermined third threshold is satisfied.

As a fifteenth case, the battery 210 is determined to be in the recharge-required state when (i) the first condition is not satisfied, that is, the remaining capacity of the battery 210 is higher than or equal to the predetermined first threshold, (ii) the second condition that the maximum capacity of the battery 210 is lower than the predetermined second threshold is satisfied, and (iii) the third condition is not satisfied, that is, the rated capacity of the battery 210 is higher than or equal to the predetermined third threshold.

As a sixteenth case, the battery 210 is determined to be in the recharge-required state when (i) the first condition that the remaining capacity of the battery 210 is lower than the predetermined first threshold is satisfied, (ii) the second condition is not satisfied, that is, the maximum capacity of the battery 210 is higher than or equal to the predetermined second threshold, and (iii) the third condition is not satisfied, that is, the rated capacity of the battery 210 is higher than or equal to the predetermined third threshold.

As a seventeenth case, the battery 210 is determined to be in the recharge-required state when (i) the first condition is not satisfied, that is, the remaining capacity of the battery 210 is higher than or equal to the predetermined first threshold, (ii) the second condition that the maximum capacity of the battery 210 is lower than the predetermined second threshold is satisfied, and (iii) the third condition is not satisfied, that is, the rated capacity of the battery 210 is higher than or equal to the predetermined third threshold.

As an eighteenth case, the battery 210 is determined to be in the recharge-required state when (i) the first condition is not satisfied, that is, the remaining capacity of the battery 210 is higher than or equal to the predetermined first threshold, (ii) the second condition is not satisfied, that is, the maximum capacity of the battery 210 is higher than or equal to the predetermined second threshold, and (iii) the third condition that the rated capacity of the battery 210 is lower than the predetermined third threshold is satisfied.

The determiner 17 is configured to compare at least one of the remaining capacity of the battery 210, the maximum capacity of the battery 210, and the rated capacity of the battery 210 with the corresponding at least one of the predetermined first threshold, the predetermined second threshold, and the predetermined third threshold to accordingly determine execution of the first determination task and the second determination task set forth above.

In particular, the determiner 17 of the first embodiment is configured to compare each of the remaining capacity of the battery 210 and the maximum capacity of the battery 210 included in the battery information with the corresponding one of the predetermined first threshold and the predetermined second threshold to accordingly determine execution of the first determination task and the second determination task.

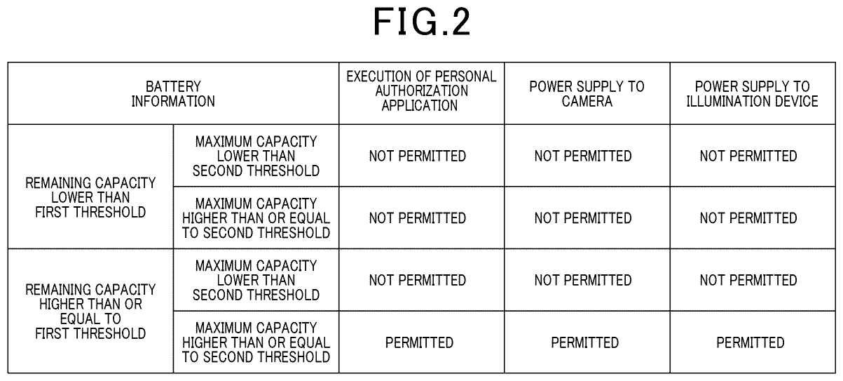

FIG. 2 shows a first example of four combination patterns among the remaining capacity of the battery 210, the predetermined first threshold, the maximum capacity of the battery 210, and the predetermined second threshold. FIG. 2 also shows, for each of the four combination patterns, (i) whether to permit activation and/or execution of the target application 51, (ii) whether to permit power supply to the camera 20, and (iii) whether to permit power supply to the illumination device 25.

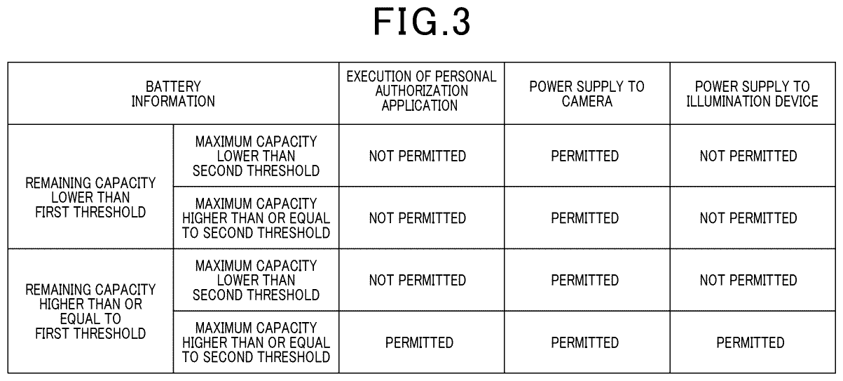

Similarly, FIG. 3 shows a second example of four combination patterns among the remaining capacity of the battery 210, the predetermined first threshold, the maximum capacity of the battery 210, and the predetermined second threshold. FIG. 3 also shows, for each of the four combination patterns, (i) whether to permit activation and/or execution of the target application 51, (ii) whether to permit power supply to the camera 20, and (iii) whether to permit power supply to the illumination device 25.

Each of FIGS. 2 and 3 shows that the battery 210 is in the recharge-required state when at least one of the first condition that that the remaining capacity of the battery 210 is lower than the predetermined first threshold and the second condition that the maximum capacity of the battery 210 is lower than the predetermined second threshold is satisfied. That is, the battery 210 is in the recharge-required state when the logical OR condition between the first and second conditions is true.

In other words, each of FIGS. 2 and 3 shows that the battery 210 is not in the recharge-required state when neither the first condition that that the remaining capacity of the battery 210 is lower than the predetermined first threshold is satisfied nor the second condition that the maximum capacity of the battery 210 is lower than the predetermined second threshold is satisfied. That is, the battery 210 is not in the recharge-required state when both the first condition and the second condition are not satisfied.

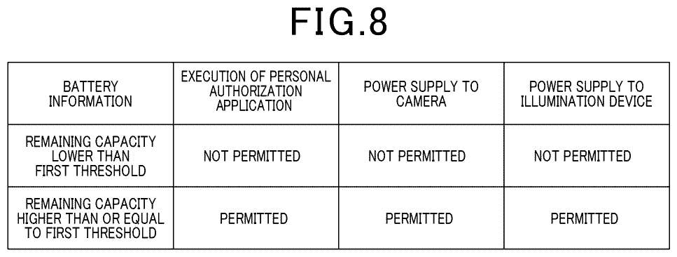

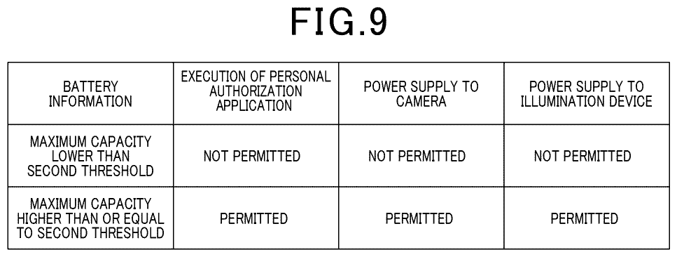

Each of FIGS. 2 and 3 shows that the battery 210 is determined to be in the recharge-required state or not in the recharge-required state in accordance with the remaining capacity of the battery 210 and the maximum capacity of the battery 210, but, as illustrated in each of FIGS. 8 and 9 described later, the battery 210 can be determined to be in the recharge-required state or not in the recharge-required state in accordance with any one of the remaining capacity of the battery 210, the maximum capacity of the battery 210, and the rated capacity of the battery 210.

Specifically, the first combination pattern of the first example illustrated in FIG. 2 shows that the remaining capacity of the battery 210 is higher than or equal to the first threshold, and the maximum capacity of the battery 210 is higher than or equal to the second threshold. In the first combination pattern of the first example, the determiner 17 determines to permit activation and/or execution of the target application 51, and to permit power supply to each of the camera 20 and the illumination device 25.

Each of the other second to fourth combination patterns of the first example illustrated in FIG. 2 shows that either the remaining capacity of the battery 210 is lower than the first threshold or the maximum capacity of the battery 210 is lower than the second threshold. In each of the second to fourth combination patterns of the first example, the determiner 17 determines not to permit activation and/or execution of the target application 51, and not to permit power supply to each of the camera 20 and the illumination device 25. This makes it possible to reduce battery-power consumption under certain conditions where charging the battery 210 is difficult.

The first combination pattern of the second example illustrated in FIG. 3 shows that the remaining capacity of the battery 210 is higher than or equal to the first threshold, and the maximum capacity of the battery 210 is higher than or equal to the second threshold. In the first combination pattern of the second example, the determiner 17 determines to permit activation and/or execution of the target application 51, and to permit power supply to each of the camera 20 and the illumination device 25.

Each of the other second to fourth combination patterns of the second example illustrated in FIG. 3 shows that either the remaining capacity of the battery 210 is lower than the first threshold or the maximum capacity of the battery 210 is lower than the second threshold. In each of the second to fourth combination patterns of the second example, the determiner 17 determines not to permit activation and/or execution of the target application 51, and not to permit power supply to one of the information acquisition/support devices AD, such as the illumination device 25, but determines to permit power supply to another of the information acquisition/support devices AD, such as the camera 20. Because the illumination device 25 includes the power source, such as the LED power source, power consumption of the illumination module is generally higher than that of the camera 20. From this viewpoint, the determiner 17 can be configured to determine not to permit power supply to the illumination device 25, but permit power supply to the camera 20. This is because, although power supply to the illumination device 25 is not permitted due to a significant impact on the battery 21, power supply to the camera 20 is permitted due to a minimal impact on the battery 21.

The above configuration, which does not permit power supply to the illumination device 25 and does not permit activation and/or execution of the target application 51 under certain conditions where charging of the battery 210 is difficult, makes it possible to reduce battery-power consumption.

Additionally, the above configuration of the ECU 11 makes it possible to individually determine power supply to each of the information acquisition/support devices AD in accordance with power consumption of each of the information acquisition/support devices AD.

The nonvolatile memory region 12a of the storage device 12 according to the first embodiment stores the first threshold and the second threshold.

The nonvolatile memory region 12a of the storage device 12 also stores first chart data representing the four combination patterns illustrated as a table-like format in FIG. 2, which include the relationship among (i) the remaining capacity of the battery 210, (ii) the first threshold, (iii) the maximum capacity of the battery 210, (iv) the predetermined second threshold, (v) whether to permit activation and/or execution of the target application 51, (vi) whether to permit power supply to the camera 20, and (vii) whether to permit power supply to the illumination device 25.

Additionally, the nonvolatile memory region 12a of the storage device 12 stores second chart data representing the four combination patterns illustrated as a table-like format in FIG. 3, which include the relationship among (i) the remaining capacity of the battery 210, (ii) the first threshold, (iii) the maximum capacity of the battery 210, (iv) the predetermined second threshold, (v) whether to permit activation and/or execution of the target application 51, (vi) whether to permit power supply to the camera 20, and (vii) whether to permit power supply to the illumination device 25.

The CPU 11a of the ECU 11 is programmed to retrieve, from the nonvolatile memory region 12a, the first threshold, the second threshold, the first chart data, and the second chart date stored in the nonvolatile memory region 12a to accordingly execute the startup-related determination routine.

The determiner 17 is configured to determine whether personal authorization of the driver of the vehicle V has been carried out in response to the network communication unit 112 receiving the ignition-on signal from the ignition button 202, i.e., detecting the operation of the ignition button 202 for transition of the vehicle V from the ignition-off state to the ignition-on state.

When determining that personal authorization of the driver of the vehicle V has not been carried out before the ignition-on state of the vehicle V, the determiner 17 is configured to determine to permit activation and/or execution of the target application 51 and permit power supply to each of the camera 20 and the illumination device 25 in response to the network communication unit 112 receiving the ignition-on signal from the ignition button 202, i.e., detecting the operation of the ignition button 202 for transition of the vehicle V from the ignition-off state to the ignition-on state.

### Ignition-Off Related Routine in Response to Ignition Off

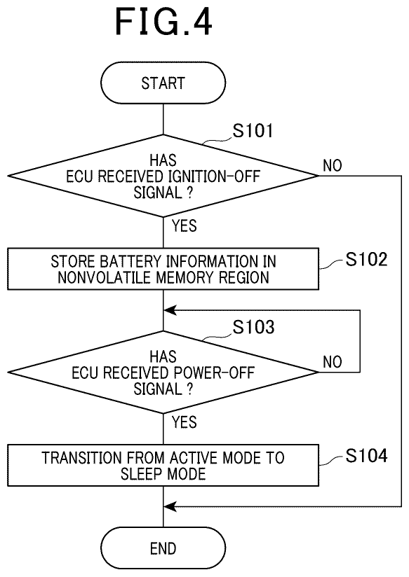

The following describes an ignition-off related routine carried out by the ECU 11 in accordance with corresponding program instructions stored in the storage device 12 with reference to the flowchart of FIG. 4.

In particular, the ECU 11 is programmed to execute the ignition-off related routine every predetermined period during the ignition-on state of the vehicle V.

When starting the ignition-off related routine, the ECU 11 serves as, for example, the determiner 117 to determine whether the network communication unit 112 has received the ignition-off signal generated by the driver's operation of the ignition button 202 during the one or more predetermined vehicle-stop conditions being satisfied in step S101.

In response to determination that the network communication unit 112 has not received the ignition-off signal (NO in step S101), the ECU 11 terminates the present cycle of the ignition-off related routine, and starts to execute the next cycle of the ignition-off related routine after lapse of the predetermine period.

Otherwise, in response to determination that the network communication unit 112 has received the ignition-off signal (YES in step S101), the ignition-off related routine proceeds to step S102.

Next, the ECU 11 serves as, for example, the storing unit 15 to store, in the nonvolatile memory region 12a, the battery information newly monitored by the battery-state monitor 14 immediately before the transition of the vehicle V from the ignition-on state to the ignition-off state in step S102.

Following the operation in step S102, the ECU 11 serves as, for example, the determiner 17 to determine whether the power management unit 111 has received the power-off signal for the ECU 11 from, for example, the door open/close switches 201 in step S103. For example, the power management unit 111 has received the power-off signal for the ECU 11 that is generated in response to all the door open/close switches 201 having detected corresponding door locks.

In response to determination that the power management unit 111 has not received the power-off signal for the ECU 11 (NO in step S103), the CPU 11a repeats the determination in step S103.

Otherwise, in response to determination that the power management unit 111 has received the power-off signal for the ECU 11 (YES in step S103), the ignition-off related routine proceeds to step S104.

In step S104, the ECU 11 serves as, for example, the determiner 17 to instruct the power management unit 111 to transition from the active mode to the sleep mode, that is, the ECU 11 transitions from the active mode to the sleep mode. Thereafter, the CPU 11a terminates the ignition-off related routine.

### Startup-Related Determination Routine

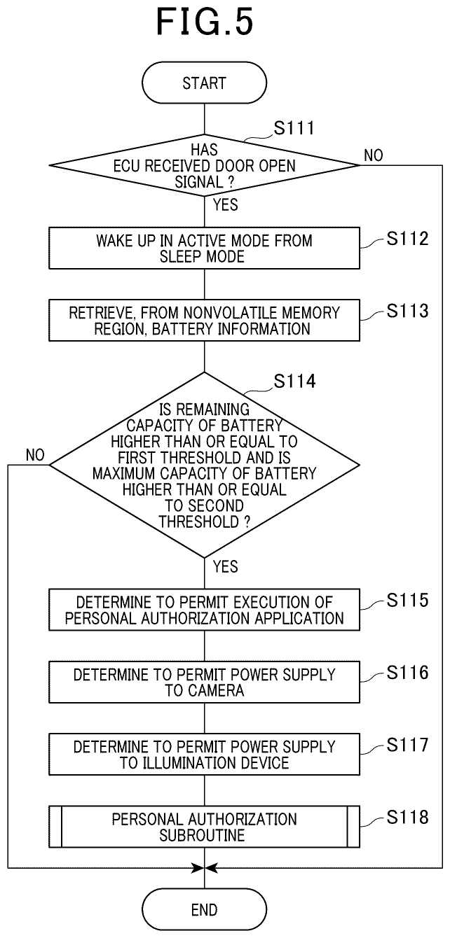

Next, the following describes the startup-related determination routine carried out by the ECU 11 in accordance with corresponding program instructions stored in the storage device 12 with reference to the flowchart of FIG. 5.

In particular, the ECU 11 is programmed to execute the startup-related determination routine every predetermined period in the sleep mode.

When starting the startup-related determination routine, the ECU 11 serves as, for example, the determiner 17 to determine whether the power management unit 111 has received the door open signal from any of the door open/close switches 201 in step S111.

In response to determination that the power management unit 111 has not received the door open signal (NO in step S111), the ECU 11 terminates the present cycle of the startup-related determination routine, and starts to execute the next cycle of the startup-related determination routine after lapse of the predetermine period.

Otherwise, in response to determination that the power management unit 111 has received the door open signal from any of the door open/close switches 201 (YES in step S111), the ECU 11 determines the occurrence of the power-on startup event for the ECU 11, i.e., the vehicle V. Then, the startup-related determination routine proceeds to step S112.

In step S112, the power management system 111 of the ECU 11 wakes up in the active mode from the sleep mode, and supplies, to each component of the ECU 11, operating power acquired based on the power supplied from the battery 210, thus activating each component of the ECU 11.

Following the operation in step S112, the ECU 11 serves as, for example, the information acquisition unit 16 to retrieve, from the nonvolatile memory region 12a, (i) the battery information at the time of last exit from the vehicle V, the first threshold, and the second threshold stored in the nonvolatile memory region 12a in step S113.

Then, the ECU 11 serves as, for example, the determiner 17 to determine whether the battery information represents the recharge-required state in step S114. Specifically, the ECU 11 serves as, for example, the determiner 17 to determine whether both the remaining capacity of the battery 210 included in the battery information is higher than or equal to the first threshold and the maximum capacity of the battery 210 included in the battery information is higher than or equal to the second threshold in step S114.

In response to determination that either the remaining capacity of the battery 210 included in the battery information is lower than the first threshold or the maximum capacity of the battery 210 included in the battery information is lower than the second threshold (NO in step S114), the ECU 11 terminates the startup-related determination routine without activation of the personal authorization application 51.

That is, the ECU 11 is programmed not to activate the personal authorization application 51 and not to perform power supply to each of the camera 20 and the illumination device 25 in response to determination that the remaining capacity of the battery 210 is low and the maximum capacity of the battery 210 is low.

This therefore makes it possible to reduce battery-power consumption.

Otherwise, in response to determination that both the remaining capacity of the battery 210 included in the battery information is higher than or equal to the first threshold and the maximum capacity of the battery 210 included in the battery information is higher than or equal to the second threshold (YES in step S114), the startup-related determination routine proceeds to step S115.

In step S115, the ECU 11 serves as, for example, the determiner 17 to determine to permit activation and execution of the personal authorization application 51. Next, the ECU 11 serves as, for example, the determiner 17 to determine to permit power supply from the battery 210 to the camera 20, so that the camera 20 is activated based on the power supplied from the battery 210 in step S116. Next, the ECU 11 serves as, for example, the determiner 17 to determine to permit power supply from the battery 210 to the illumination device 25, so that the illumination device 25 is activated based on the power supplied from the battery 210 in step S117.

This enables the camera system comprised of the activated camera 20 and the activated illumination device 25 to start capturing of one or more images, each of which includes the face of the driver. The order of the operations in steps S115, S116, and S117 can be reversed.

Following the operation in step S117, the ECU 11 runs the personal authorization application 51 to accordingly execute a personal authorization subroutine in step S118.

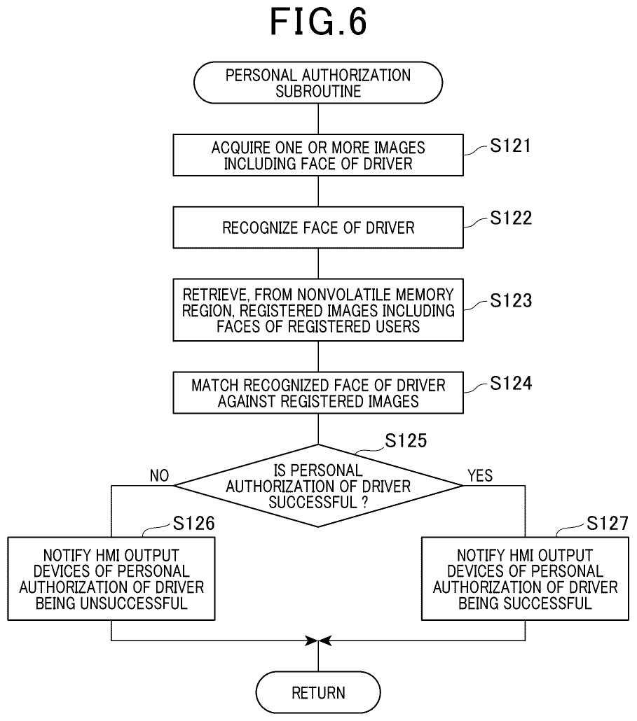

FIG. 6 illustrates a flowchart indicative of the personal authorization subroutine in step S118.

When starting the personal authorization subroutine in step S118, the ECU 11 acquires the one of more images captured by the camera system in step S121; each of the images includes the face of the driver.

Next, the ECU 11 performs one or more known image-recognition approaches to accordingly recognize, for example, the face of the driver in step S122.

Following the operation in step S122, the ECU 11 retrieves, from the nonvolatile memory region 12a, registered images stored in the nonvolatile memory region 12a as the pre-registered personal information items in step S123; each of the registered images includes the face of at least one of the registered users.

Next, the ECU 11 matches the recognized face of the driver against the registered images in step to accordingly calculate the matching score between the recognized face of the driver and each of the registered images in step S124.

Then, the ECU 11 determines whether each matching score is lower than the predetermined matching threshold in step S125.

In response to determination that all the matching scores are lower than the predetermined matching threshold, the ECU 11 determines that the personal authorization of the driver is unsuccessful (NO in step S125). Then, the startup-related determination routine proceeds to step S126.

In step S126, the ECU 11 notifies at least one of the HMI output devices 40 of information representing that the personal authorization of the driver is unsuccessful.

Otherwise, in response to determination that the matching score of the recognized face of the driver with at least one of the registered images is higher than or equal to the predetermined matching threshold, the ECU 11 determines that the personal authorization of the driver is successful (YES in step S125). Then, the startup-related determination routine proceeds to step S127.

In step S127, the ECU 11 notifies at least one of the HMI output devices 40 of information representing that the personal authorization of the driver is successful.

After the operation in step S126 or S127, the ECU 11 terminates the personal authorization subroutine in step S118, and returns to the main routine, i.e., the startup-related determination routine. After the personal authorization subroutine in step S118, the ECU 11 terminates the startup-related determination routine.

In step S113, if the ECU 11 cannot retrieve, from the nonvolatile memory region 12a, the battery information due to, for example, a fault in the nonvolatile memory region 12a, the ECU 11 performs the determination identical to the negative determination in step S114, and therefore terminates the startup-related determination routine. This enables power consumption of the battery 210 to be reduced when the operational state of the battery 210 is hard to acquire.

### Ignition-On Related Routine in Response to Ignition On

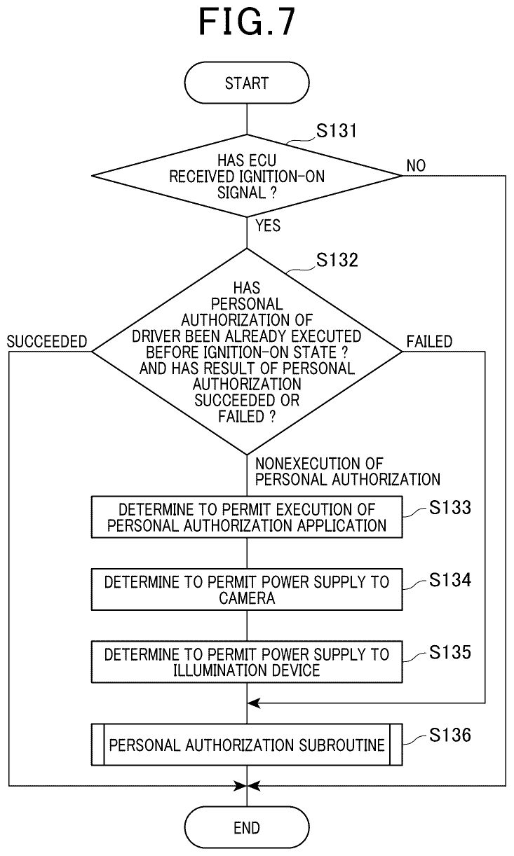

The following describes an ignition-on related routine carried out by the ECU 11 in accordance with corresponding program instructions stored in the storage device 12 with reference to the flowchart of FIG. 7.

In particular, the ECU 11 is programmed to execute the ignition-on related routine every predetermined period during the ignition-off state of the vehicle V.

When starting the ignition-on related routine, the ECU 11 serves as, for example, the determiner 117 to determine whether the network communication unit 112 has received the ignition-on signal generated by the driver's operation of the ignition button 202 during the one or more predetermined vehicle-start conditions being satisfied in step S131.

In response to determination that the network communication unit 112 has not received the ignition-on signal (NO in step S131), the ECU 11 terminates the present cycle of the ignition-on related routine, and starts to execute the next cycle of the ignition-on related routine after lapse of the predetermine period.

Otherwise, in response to determination that the network communication unit 112 has received the ignition-on signal (YES in step S131), the ignition-on related routine proceeds to step S132.

Next, in step S132, the ECU 11 serves as, for example, the determiner 17 to perform

(I) A first determination of whether the personal authorization of the driver of the vehicle V by the personal authorization application 51 has been already executed before the ignition-on state of the vehicle V

(II) A second determination, after it is determined that the personal authorization of the driver of the vehicle V has been already executed (YES in the first determination), of whether the personal authorization of the driver of the vehicle V has succeeded or failed

In response to determination that the first determination is YES and the personal authorization of the driver of the vehicle V has succeeded in the second determination (SUCCESS in step S132), the ECU 11 terminates the ignition-on related routine.

Otherwise, in response to determination that the first determination is YES and the personal authorization of the driver of the vehicle V has failed in the second determination (FAILURE in step S132), the ignition-on related routine proceeds to step S136.

Otherwise, in response to determination that the personal authorization of the driver of the vehicle V has not been executed (NO in the first determination, i.e., NON-EXECUTION in step S132), the ignition-on related routine proceeds to step S133.

In step S133, the ECU 11 serves as, for example, the determiner 17 to determine to permit activation and execution of the personal authorization application 51. Next, the ECU 11 serves as, for example, the determiner 17 to determine to permit power supply from the battery 210 to the camera 20, so that the camera 20 is activated based on the power supplied from the battery 210 in step S134. Next, the ECU 11 serves as, for example, the determiner 17 to determine to permit power supply from the battery 210 to the illumination device 25 in step S135, so that the illumination device 25 is activated based on the power supplied from the battery 210.

This enables the camera system comprised of the activated camera 20 and the activated illumination device 25 to start capturing of one or more images, each of which includes the face of the driver. The order of the operations in steps S133, S134, and S135 can be reversed.

Following the second determination in step S132 has failed or the operation in step S135, the ECU 11 runs the personal authorization application 51 to accordingly execute the personal authorization subroutine in step S118 set forth above.

After completion of the personal authorization subroutine in step S118, the ECU 11 returns to the main routine, i.e., the ignition-on related routine. Then, the ECU 11 terminates the ignition-on related routine.

When the personal authorization of the driver of the vehicle V is successful before the ignition-on state of the vehicle V, the ECU 11 is programmed to adjust, after the ignition-on state of the vehicle V, in-cabin environment settings of the vehicle V, which includes the setting of the driver's seat position and setting of the side-mirror angles, to predetermined respective settings associated with the authenticated driver of the vehicle V.

Additionally, when the personal authorization of the driver of the vehicle V is successful after the ignition-on state of the vehicle V, the ECU 11 is programmed to adjust, after the personal authorization of the driver of the vehicle V is successful, the in-cabin environment settings of the vehicle V, which includes the setting of the driver's seat position and setting of the side-mirror angles, to predetermined respective settings associated with the authenticated driver of the vehicle V.

The ECU 11 of the startup-related determination system 1 is configured to determine, at an occurrence of a power-on startup for the ECU 11, i.e., the vehicle V, whether to permit execution of a target application, such as the personal authorization application, 51 for a period from a start of power to the ECU 11 to the transition of the vehicle V to the ignition-on state

Specifically, the ECU 11 includes the battery-state monitor 14, the storing unit 15, the information acquisition unit 16, and the determiner 17.

The battery-state monitor 14 is configured to monitor the battery information representing the remaining capacity of the battery 210 and the maximum capacity of the battery 210. The storing unit 15 is configured to read the battery information monitored by the battery-state monitor 14 and store the battery information in the nonvolatile memory region 12a.

The information acquisition unit 16 is configured to acquire, when the power-on startup event for the ECU 11 occurs, the battery information stored in the nonvolatile memory region 12a. The determiner 17 is configured to determine whether to permit execution of the target application 51 based on the battery information acquired by the information acquisition unit 16.

This configuration makes it possible to determine, based on the operational state of the battery 210, whether to permit execution of the target application 51 during the ignition-off period for which the battery 210 cannot be charged. This therefore enables more appropriate control of the operational state of the battery 210, such as the remaining capacity of the battery 210, under startup of the target application 51 using the battery power, making it possible to provide the ECU 11, which is capable of more appropriately determining whether to permit execution of the target application 51 and more appropriately controlling the remaining capacity of the battery 210.

In particular, the ECU 11 is configured to refer to the battery information representing the operational state of the battery 210 at the time of last exit from the vehicle V to accordingly perform the determination of whether to permit execution of the target application 51. This configuration therefore eliminates the need of new detection of the remaining capacity and/or the maximum capacity of the battery 210 at the time of current entry to the vehicle V. That is, the ECU 10 makes the startup-related determination earlier than in a case where the remaining capacity and/or maximum capacity of the battery 210 is newly acquired at the time of entering the vehicle V.

This therefore makes it possible to prevent time from being inefficiently consumed merely for detecting the operational state of the battery 210 during which the information acquisition/support devices AD, such as the camera 20, the illumination device 25, and/or the microphone 22, cannot be operated; the above devices 20, 25, and/or 22 are required to activate and/or execute the target application 51.

The determiner 17 is configured to determine not to permit power supply to at least one of the information acquisition/support devices AD, which is required to operate the target application 51, i.e., the personal authorization application 51, in response to determination that the operational information of the battery 210 represents the recharge-required state; the recharge-required state of the battery 210 represents the amount of electrical charge in the battery 210 being lower than the predetermined electrical-charge amount.

The determiner 17 is configured to determine not to permit execution of the target application 51, i.e., the personal authorization application 51, in response to determination that either the remaining capacity of the battery 210 is lower than the first threshold or the maximum capacity of the battery 210 is lower than the second threshold.

This configuration prevents activation of the target application 51 in response to determination that the battery 210 is in a low-power state, making it possible to reduce power consumption of the battery 210 until the ignition-off state of the vehicle V transitions to the ignition-on state.

Otherwise, in response to the available power of the battery 210 being determined to be sufficient based on the remaining capacity and the maximum capacity of the battery 210, the determiner 17 is configured to permit activation of the target application 51. That is, the target application 51 is not completely unavailable during the ignition-off state of the vehicle V, i.e., before the ignition-on state of the vehicle V. Accordingly, the above configuration of the ECU 11 prevents excessive restriction of user convenience.

The determiner 17 is configured to determine not to permit power supply to at least one of the camera 20 and the illumination device 25 of the information acquisition/support devices AD, which acquires information required for execution of the target application 51 and/or supports for the acquisition of the information, in response to determination that the operational information of the battery 210 represents the recharge-required state; the recharge-required state of the battery 210 represents the amount of electrical charge in the battery 210 being lower than the predetermined electrical-charge amount.

The determiner 17 is configured to determine not to permit power supply to at least one of the camera 20 and the illumination device 25 of the information acquisition/support devices AD, which acquires information required for execution of the target application 51 and/or supports for the acquisition of the information, in response to determination that either the remaining capacity of the battery 210 is lower than the first threshold or the maximum capacity of the battery 210 is lower than the second threshold.

This configuration prevents, in addition to restriction of activation of the target application 51, activation of the camera 20 and/or the illumination device 25, which acquires images or sound waves required for execution of the target application 51 and/or supports for the acquisition of the images or sound waves, in response to determination that the battery 210 is in a low-power state. This therefore makes it possible to reduce power consumption of the battery 210 under certain conditions where charging the battery 210 is difficult during the ignition-off state of the vehicle V.

The battery 210 is determined to be in the recharge-required state of the battery 210 when (i) the first condition that the remaining capacity of the battery 210 is lower than the first threshold is satisfied, (ii) the second condition that the maximum capacity of the battery 210 is lower than the threshold is satisfied, (iii) the third condition that the rated capacity of the battery 210 is lower than then third threshold is satisfied, or any combination of the first to third conditions is satisfied.

The ECU 11 therefore makes it possible to perform the startup-related determination routine based on the battery information and the first and second thresholds, which are relatively easy to obtain and not excessively large in size. This therefore suppresses the computing load on the ECU 11 and/or prevents excessive consumption of the nonvolatile memory region 12a.

The determiner 17 is configured to permit both (i) execution of the target application 51, i.e., the personal authorization application 51, and (ii) power supply to the camera 20 and the illumination device 25 in response to transition of the vehicle V from the ignition-off state to the ignition-on state.

This configuration enables, after the ignition-on state, execution of the personal authorization of the driver under conditions where the battery 210 can be charged even if no personal authentication has been performed due to the battery status or even if the personal authentication has failed once, making it possible to improve the user's convenience.

The ECU 11 of the startup-related determination system 1 according to the first embodiment is configured to perform the startup-related determination routine based on both the remaining capacity and the maximum capacity of the battery 210 included in the battery information at the time of last exit from the vehicle V. The present disclosure is, however, not limited to the above configuration.

For example, the ECU 11 according to a first modification of the first embodiment may be configured to perform the startup-related determination routine based on any one of the remaining capacity and the maximum capacity of the battery 210 included in the battery information at the time of last exit from the vehicle V.

More specifically, the battery information according to the first modification of the first embodiment includes the remaining capacity of the battery 210, and the ECU 11 may be configured to perform the startup-related determination routine based on the remaining capacity of the battery 210 included in the battery information at the time of last exit from the vehicle V.

FIG. 8 shows an example of two combination patterns among the remaining capacity of the battery 210 and the first threshold according to the first modification of the first embodiment, and also shows, for each of the two combination patterns, (i) whether to permit activation and/or execution of the target application 51, (ii) whether to permit power supply to the camera 20, and (iii) whether to permit power supply to the illumination device 25.

The nonvolatile memory region 12a of the storage device 12 according to the first modification of the first embodiment may store chart data indicative of the two combination patterns illustrated in FIG. 8.

Specifically, the determiner 17 according to the first modification of the first embodiment is configured to determine, as illustrated in FIG. 8, not to permit (i) activation and/or execution of the target application 51 and (ii) power supply to the information acquisition/support devices AD, such as the camera 20 and the illumination device 25, in response to determination that the remaining capacity of the battery 210 is lower than the first threshold.

In contrast, the determiner 17 according to the first modification of the first embodiment is configured to determine, as illustrated in FIG. 8, to permit (i) activation and/or execution of the target application 51 and (ii) power supply to the information acquisition/support devices AD, such as the camera 20 and the illumination device 25, in response to determination that the remaining capacity of the battery 210 is higher than or equal to the first threshold.

This makes it possible to reduce battery-power consumption under certain conditions where the remaining capacity of the battery 210 is low and charging the battery 210 is difficult.

The ECU 11 according to the first modification of the first embodiment is configured to perform the startup-related determination routine based on the remaining capacity of the battery 210 without consideration of the maximum capacity of the battery 210 and the rated capacity of the battery 210.

Additionally, the battery information according to the second modification of the first embodiment includes the maximum capacity of the battery 210, and the ECU 11 may be configured to perform the startup-related determination routine based on the maximum capacity of the battery 210 included in the battery information at the time of last exit from the vehicle V.

FIG. 9 shows an example of two combination patterns among the maximum capacity of the battery 210 and the second threshold according to the second modification of the first embodiment, and also shows, for each of the two combination patterns, (i) whether to permit activation and/or execution of the target application 51, (ii) whether to permit power supply to the camera 20, and (iii) whether to permit power supply to the illumination device 25.

The nonvolatile memory region 12a of the storage device 12 according to the second modification of the first embodiment may store chart data indicative of the two combination patterns illustrated in FIG. 9.

Specifically, the determiner 17 according to the second modification of the first embodiment is configured to determine, as illustrated in FIG. 9, not to permit (i) activation and/or execution of the target application 51 and (ii) power supply to the information acquisition/support devices AD, such as the camera 20 and the illumination device 25, in response to determination that the maximum capacity of the battery 210 is lower than the second threshold.

In contrast, the determiner 17 according to the second modification of the first embodiment is configured to determine, as illustrated in FIG. 9, to permit (i) activation and/or execution of the target application 51 and (ii) power supply to the information acquisition/support devices AD, such as the camera 20 and the illumination device 25, in response to determination that the maximum capacity of the battery 210 is higher than or equal to the second threshold.

This makes it possible to reduce battery-power consumption under certain conditions where the maximum capacity of the battery 210 is low and charging the battery 210 is difficult.

The ECU 11 according to the second modification of the first embodiment is configured to perform the startup-related determination routine based on the maximum capacity of the battery 210 without consideration of the remaining capacity of the battery 210 and the rated capacity of the battery 210.

The battery information according to the third modification of the first embodiment includes the specification information on the battery 210, and the ECU 11 may be configured to perform the startup-related determination routine based on the specification information on the battery 210 included in the battery information at the time of last exit from the vehicle V. The specification information on the battery 210 includes, for example, the rated capacity of the battery 210. The rated capacity of the battery 210 may vary depending on the vehicle model.

For example, if the startup-related system 1 is installed in a vehicle, such as a Kei-car, equipped with the battery 210 having a very low rated capacity, the determiner 17 may be configured to determine not to permit execution of the target application 51 under certain conditions where charging the battery 210 is difficult.

In contrast, if the startup-related system 1 is installed in a vehicle, such as a pickup truck, equipped with the battery 210 having a relatively large rated capacity, the determiner 17 may be configured to determine to permit execution of the target application 51 even under certain conditions where charging the battery 210 is difficult.

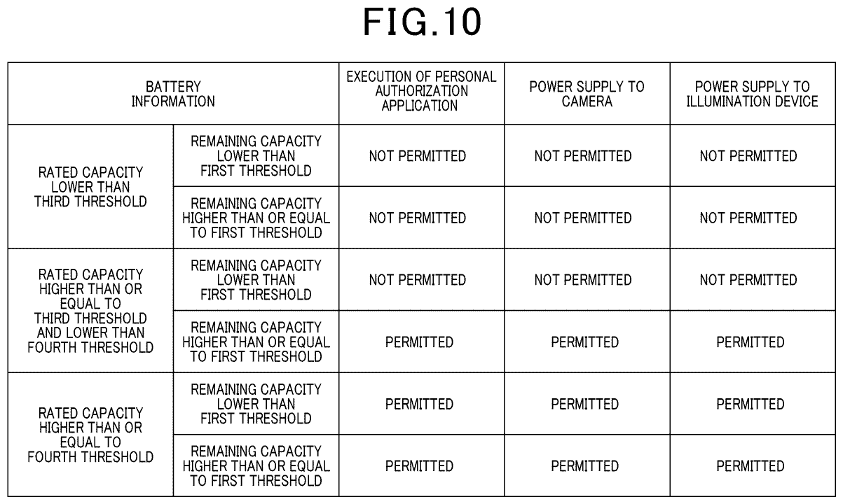

FIG. 10 shows an example of six combination patterns among the remaining capacity of the battery 210, the first threshold, the rated capacity of the battery 210, the third threshold, and a predetermined fourth threshold, and also shows, for each of the six combination patterns, (i) whether to permit activation and/or execution of the target application 51, (ii) whether to permit power supply to the camera 20, and (iii) whether to permit power supply to the illumination device 25. The fourth threshold is set to be higher than the third threshold.

The nonvolatile memory region 12a of the storage device 12 according to the third modification of the first embodiment may store chart data indicative of the six combination patterns illustrated in FIG. 10.

Specifically, the determiner 17 according to the third modification of the first embodiment is configured to determine, as illustrated in FIG. 10, not to permit (i) activation and/or execution of the target application 51 and (ii) power supply to the information acquisition/support devices AD, such as the camera 20 and the illumination device 25, in response to determination that the rated capacity of the battery 210 is lower than the third threshold independently of whether the remaining capacity of the battery 210 is lower than the first threshold.

The determiner 17 according to the third modification of the first embodiment is configured to determine, as illustrated in FIG. 10, to permit (i) activation and/or execution of the target application 51 and (ii) power supply to the information acquisition/support devices AD, such as the camera 20 and the illumination device 25, in response to determination that the rated capacity of the battery 210 is higher than or equal to the third threshold and lower than the fourth threshold and the remaining capacity of the battery 210 is higher than or equal to the first threshold.

In contrast, the determiner 17 according to the third modification of the first embodiment is configured to determine, as illustrated in FIG. 10, not to permit (i) activation and/or execution of the target application 51 and (ii) power supply to the information acquisition/support devices AD, such as the camera 20 and the illumination device 25, in response to determination that, even if the rated capacity of the battery 210 is higher than or equal to the third threshold and lower than the fourth threshold, the remaining capacity of the battery 210 is lower than the first threshold.

The determiner 17 according to the third modification of the first embodiment is configured to determine, as illustrated in FIG. 10, to permit (i) activation and/or execution of the target application 51 and (ii) power supply to the information acquisition/support devices AD, such as the camera 20 and the illumination device 25, in response to determination that the rated capacity of the battery 210 is higher than or equal to the fourth threshold independently of whether the remaining capacity of the battery 210 is lower than the first threshold.

This makes it possible to reduce battery-power consumption under certain conditions where the rated capacity of the battery 210 is very low and charging the battery 210 is difficult. This configuration, which enables usage of the target application 51 under charging of the battery 210 is difficult as long as the rated capacity of the battery 210 is a relatively high, makes it possible to improve the user's convenience.

The ECU 11 according to the third modification of the first embodiment is configured to perform the startup-related determination routine based on the remaining capacity and the rated capacity of the battery 210 without consideration of the maximum capacity of the battery 210.

The startup-related determination module 10 according to the first embodiment is mounted on the same circuit board of the ECU 11, but the startup-related determination module 10 may be mounted on an alternative circuit board different from the circuit board of the ECU 11.

The ECU 11 can be comprised of physically separated components, which respectively serve as the above functional components 14, 112, 113, 13, 15, 16, and 17. An external device carried in the vehicle V by a driver can serve as a part of the startup-related system 2.

### Second Embodiment

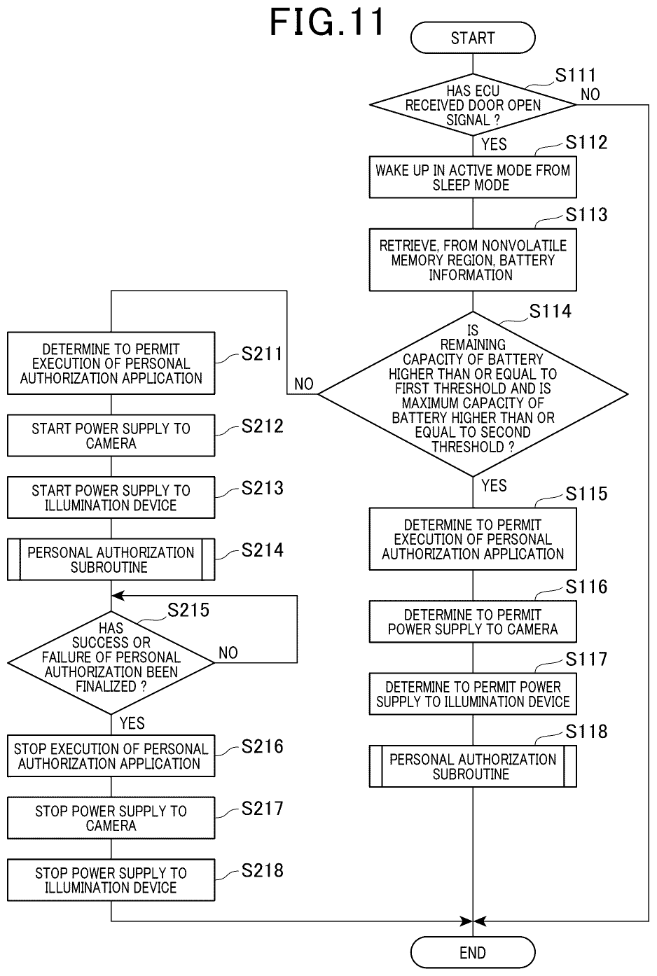

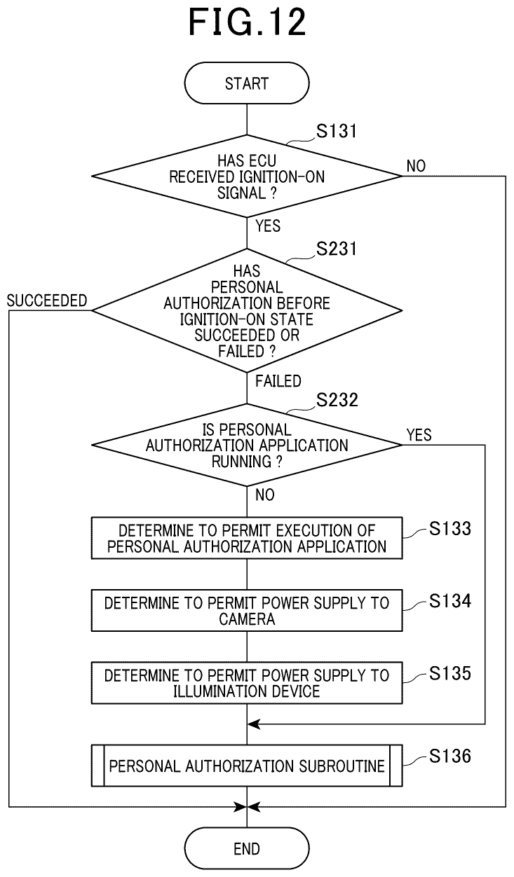

The following describes the second embodiment with reference to FIGS. 11 and 12.

The ECU 11 of the startup-related determination system 1 according to the second embodiment is configured to determine to permit activation and/or execution of the target application 51 in the ignition-off state of the vehicle V independently of the battery information at the time of last exit from the vehicle V.

In response to determination that the battery information at the time of last exit from the vehicle V represents the recharge-required state, the ECU 11 is configured to suspend, after the execution result of the target application 51 is determined, (i) the execution of the target application 51 and (ii) power supply to the information acquisition/support devices AD until the ignition-off state of the vehicle V transitions to the ignition-on state. This makes it possible to permit, even when the battery 210 is determined to be in a low-power state, execution of the target application 51 at least once, thus improving user convenience.

Specifically, the ECU 11 of the second embodiment is configured to permit (i) execution of the personal authorization application 51 and (ii) power supply to the camera 20 and the illumination device 25 included in the information acquisition/support devices AD in the power-on state of the ECU 11. In response to determination that the battery information at the time of last exit from the vehicle V represents the recharge-required state, the ECU 11 is configured to stop power supply to at least one of the camera 20 and the illumination device 25 after the personal authorization result of the personal authorization application 51 is determined to be successful or unsuccessful.

This makes it possible to permit, even when the battery 210 is determined to be in the recharge-required state, execution of the personal authorization application 51 to thereby improve user convenience.

In response to the personal authorization result of the personal authorization application 51 being determined to be successful in the ignition-off state of the vehicle V, the ECU 11 is capable of executing various tasks when the personal authorization of the driver is successful immediately after the ignition-off state of the vehicle V transitions to the ignition-on state. This therefore makes it possible to reduce waiting time required to adjust various environmental settings in the vehicle V to predetermined respective settings associated with the authenticated driver.

### Startup-Related Determination Routine

Next, the following describes the startup-related determination routine carried out by the ECU 11 of the second embodiment in accordance with corresponding program instructions stored in the storage device 12 with reference to the flowchart of FIG. 11. The ECU 11 is programmed to execute the startup-related determination routine every predetermined period in the sleep mode.

In particular, the following describes mainly operations of the startup-related determination routine illustrated in FIG. 11 different from the operations of the startup-related determination routine illustrated in FIG. 5.

In response to determination that either the remaining capacity of the battery 210 included in the battery information is lower than the first threshold or the maximum capacity of the battery 210 included in the battery information is lower than the second threshold (NO in step S114), the startup-related determination routine proceeds to step S211.

In step S211, the ECU 11 serves as, for example, the determiner 17 to determine to permit activation and execution of the personal authorization application 51. Next, the ECU 11 serves as, for example, the determiner 17 to start power supply from the battery 210 to the camera 20, so that the camera 20 is activated based on the power supplied from the battery 210 in step S212. Next, the ECU 11 serves as, for example, the determiner 17 to start power supply from the battery 210 to the illumination device 25, so that the illumination device 25 is activated based on the power supplied from the battery 210 in step S213.

This enables the camera system comprised of the activated camera 20 and the activated illumination device 25 to start capturing of one or more images, each of which includes the face of the driver. The order of the operations in steps S211, S212, and S213 can be reversed.

Following the operation in step S213, the ECU 11 runs the personal authorization application 51 to accordingly execute the personal authorization subroutine in step 214, which is identical to the subroutine in step S118. This therefore makes it possible to execute, in the ignition-off state of the vehicle V, the personal authorization of the driver of the vehicle V at least once.

Following the operation in step S214, the ECU 11 serves as, for example, determiner 17 to determine whether the success or failure of the personal authorization executed by the personal authorization application 51 has been finalized in step S215.

In response to determination that the success or failure of the personal authorization executed by the personal authorization application 51 has not been finalized (NO in step S215), the ECU 11 repeats the determination in step S215 so as to wait for completion of the personal authorization executed by the personal authorization application 51.

Otherwise, in response to determination that the success or failure of the personal authorization executed by the personal authorization application 51 has been finalized (YES in step S215), startup-related determination routine proceeds to step S216.

In step S216, the ECU 11 stops execution of the personal authorization application 51, and stops power supply to the camera 20 to thereby deactivate the camera 20 in step S217. Next, the ECU 11 power supply to the illumination device 25 to thereby deactivate the illumination device 25 in step S218. The order of the operations in steps S216, S217, and S218 can be reversed.

The ECU 11 according to the second embodiment therefore makes it possible to reduce, once the personal authorization of the driver has been performed, further power consumption of the battery 210 under certain conditions where the battery 210 is in a low-power state.

After the operation in step S218, the ECU 11 terminates the startup-related determination routine.

The ECU 11 according to the second embodiment is configured to stop, after the success or failure of the personal authorization executed by the personal authorization application 51 has been finalized, power supply to each of the camera 20 and the illumination device 25 in response to determination that the battery information on the battery 210 represents the recharge-required state. The present disclosure is, however, not limited to the above configuration.

Specifically, the ECU 11 according to a first modification of the second embedment may be configured to maintain, after the success or failure of the personal authorization executed by the personal authorization application 51 has been finalized, power supply to the camera 20 whose power consumption is lower than that of the illumination device 25 and stop power supply to the illumination device 25 in response to determination that the battery information on the battery 210 represents the recharge-required state.

The first modification of the second embodiment enables the period required for activation of the camera 20, which is included in the period required for the camera system to be available, to be shorter.

The startup-related determination routine illustrated in FIG. 11 is carried out based on the first chart data illustrated in FIG. 2, but the present disclosure is not limited thereto.

For example, the startup-related determination routine according to the second embodiment may be carried out based on any one of the second chart data illustrated in FIG. 3, the chart data illustrated in FIG. 8, or the chart data illustrated in FIG. 10.

### Ignition-On Related Routine in Response to Ignition On

The following describes the ignition-on related routine carried out by the ECU 11 according to the second embodiment in accordance with corresponding program instructions stored in the storage device 12 with reference to the flowchart of FIG. 12. In particular, the ECU 11 is programmed to execute the ignition-on related routine every predetermined period during the ignition-off state of the vehicle V.

In particular, the following describes mainly operations of the ignition-on related routine illustrated in FIG. 12 different from the operations of the ignition-on related routine illustrated in FIG. 7.

In response to determination that the network communication unit 112 has received the ignition-on signal (YES in step S131), the ignition-on related routine proceeds to step S231.

Next, in step S231, the ECU 11 serves as, for example, the determiner 17 to determine whether the personal authorization executed by the personal authorization application 51 before the ignition-on state of the vehicle, i.e., during the ignition-off sate, has succeeded or failed.

In response to determination that the personal authorization of the driver of the vehicle V has succeeded (SUCCESS in step S231), the ECU 11 terminates the ignition-on related routine.

Otherwise, in response to determination that the personal authorization of the driver of the vehicle V has failed (FAILURE in step S231), the ignition-on related routine proceeds to step S232.

In step S232, the ECU 11 serves as, for example, the determiner 17 to determine whether the personal authorization application 51 is running. In response to determination that the personal authorization application 51 is running (YES in step S232), the ignition-on related routine proceeds to step S136.

Otherwise, in response to determination that the personal authorization of the driver of the vehicle V is not running (NO in step S232), the ignition-on related routine proceeds to step S133.

That is, the ECU 11 of the second embodiment is configured to execute the ignition-on related routine in response to transition of the vehicle V from the ignition-off state to the ignition-on state.

The determiner 17 of the ECU 11 according to the second embodiment described above is configured to determine to permit (i) execution of the personal authorization application 51 as the target application 51 and (ii) power supply to the camera 20 and the illumination device 25, which are required to operate the personal authorization application 51, in response to determination that the operational information of the battery 210 represents the recharge-required state; the recharge-required state of the battery 210 represents the amount of electrical charge in the battery 210 being lower than the predetermined electrical-charge amount.

Then, the determiner 17 of the ECU 11 is configured to stop execution of the personal authorization application 51 and stop power supply to at least one of the camera 20 and the illumination device 25 after the success or failure of the personal authorization executed by the personal authorization application 51 has been finalized.

The determiner 17 of the ECU 11 is configured to determine to permit execution of the personal authorization application 51 and power supply to the camera 20 and the illumination device 25 of the information acquisition/support devices AD, which acquire information required for execution of the target application 51 and/or supports for the acquisition of the information, in response to determination that either the remaining capacity of the battery 210 is lower than the first threshold or the maximum capacity of the battery 210 is lower than the second threshold.

Then, the determiner 17 of the ECU 11 is configured to stop execution of the personal authorization application 51 and stop power supply to at least one of the camera 20 and the illumination device 25 after the success or failure of the personal authorization executed by the personal authorization application 51 has been finalized.

Even under certain conditions where the remaining capacity of the battery 210 is low and charging the battery 210 is difficult, this configuration of the ECU 11 permits the personal authorization application 51 and the camera system comprised of the camera 20 and the illumination device 25 to execute the personal authorization once, and thereafter, stops the execution of the personal authorization application 51 and the power supply to at least one of the camera 20 and the illumination device 25. This therefore reduces further power consumption of the battery 210 until the ignition-off state of the vehicle V transitions to the ignition-on state in which the battery 210 is chargeable.

Additionally, this configuration of the ECU 11 executes the personal authorization of the driver once even under a case where the battery 210 is in a low-power state. This therefore enables various environmental settings in the vehicle V to be smoothly adjusted to predetermined respective settings associated with the authenticated driver after transition of the ignition-off state of the vehicle V to the ignition-on state. This therefore reduces power consumption of the battery 210 while maintaining the driver's convenience as high as possible.

### Third Embodiment

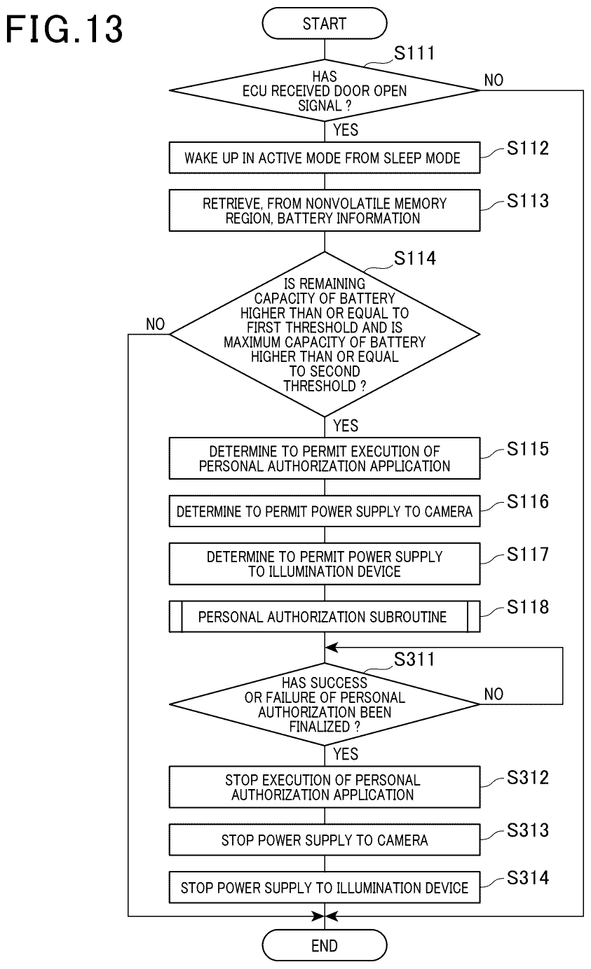

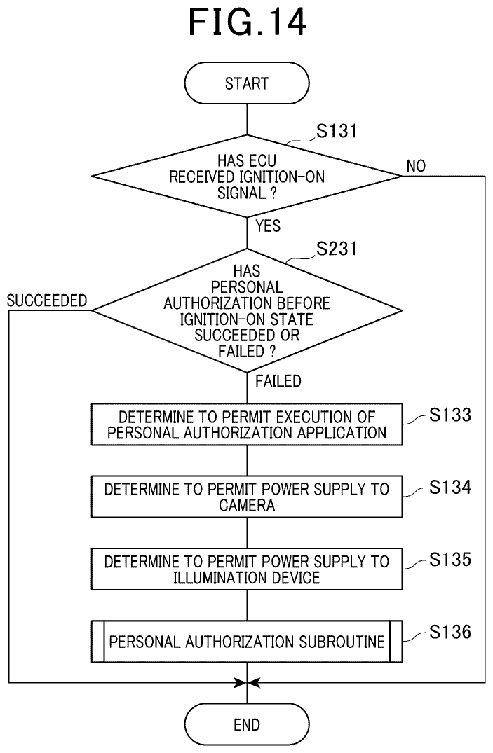

The following describes the third embodiment with reference to FIGS. 13 and 14.

Like the first embodiment, the ECU 11 of the startup-related determination system 1 according to the third embodiment is configured to determine not to permit (i) execution of the target application 51 and (ii) power supply to the information acquisition/support devices AD in response to determination that the battery information at the time of last exit from the vehicle V represents the recharge-required state. In contrast, the ECU 11 of the startup-related determination system 1 according to the third embodiment is configured to determine to permit (i) execution of the target application 51 and (ii) power supply to the information acquisition/support devices AD in response to determination that the battery information at the time of last exit from the vehicle V represents a high-charge state.

The high-charge state of the battery 210 according to the third embodiment represents that the remaining capacity of the battery 210 is higher than or equal to the first threshold, and the maximum capacity of the battery 210 is higher than or equal to the second threshold.

Additionally, even if the battery information at the time of last exit from the vehicle V represents the high-charge state, the ECU 11 according to the third embodiment is configured to stop (i) execution of the target application 51 and (ii) power supply to the information acquisition/support devices AD after the one-time execution result of the target application 51 is determined until the ignition-off state of the vehicle V transitions to the ignition-on state. This makes it possible to reduce, even if the battery 210 is not in a low-power state, further power consumption of the battery 210 under certain conditions where charging of the battery 210 is difficult in the ignition-off state of the vehicle V.

Specifically, the ECU 11 of the third embodiment is configured to permit (i) execution of the personal authorization application 51 and (ii) power supply to the camera 20 and the illumination device 25 included in the information acquisition/support devices AD in the power-on state of the ECU 11 and in the ignition-off state of the vehicle V.

After the personal authorization result of the personal authorization application 51 is determined to be successful or unsuccessful, the ECU 11 is configured to stop (i) execution of the personal authorization application 51 and (ii) power supply to at least one of the camera 20 and the illumination device 25.

### Startup-Related Determination Routine

Next, the following describes the startup-related determination routine carried out by the ECU 11 of the third embodiment in accordance with corresponding program instructions stored in the storage device 12 with reference to the flowchart of FIG. 13. The ECU 11 is programmed to execute the startup-related determination routine every predetermined period in the sleep mode.

In particular, the following describes mainly operations of the startup-related determination routine illustrated in FIG. 13 different from the operations of the startup-related determination routine illustrated in FIG. 5.

After completion of the personal authorization subroutine in step S118, the ignition-on related routine proceeds to step S311.

In step S311, the ECU 11 serves as, for example, determiner 17 to determine whether the success or failure of the personal authorization executed by the personal authorization application 51 has been finalized.

In response to determination that the success or failure of the personal authorization executed by the personal authorization application 51 has not been finalized (NO in step S311), the ECU 11 repeats the determination in step S311 so as to wait for completion of the personal authorization executed by the personal authorization application 51.

Otherwise, in response to determination that the success or failure of the personal authorization executed by the personal authorization application 51 has been finalized (YES in step S311), the startup-related determination routine proceeds to step S312.

In step S312, the ECU 11 stops execution of the personal authorization application 51, and stops power supply to the camera 20 to thereby deactivate the camera 20 in step S313. Next, the ECU 11 power supply to the illumination device 25 to thereby deactivate the illumination device 25 in step S314. The order of the operations in steps S312, S313, and S314 can be reversed.

The ECU 11 according to the third embodiment therefore makes it possible to reduce, once the personal authorization of the driver has been performed, further power consumption of the battery 210 under certain conditions where charging of the battery 210 is difficult.

After the operation in step S314, the ECU 11 terminates the startup-related determination routine.

The startup-related determination routine illustrated in FIG. 13 is carried out based on the first chart data illustrated in FIG. 2, but the present disclosure is not limited thereto.

For example, the startup-related determination routine according to the third embodiment may be carried out based on any one of the second chart data illustrated in FIG. 3, the chart data illustrated in FIG. 8, or the chart data illustrated in FIG. 10.

### Ignition-On Related Routine in Response to Ignition On

The following describes the ignition-on related routine carried out by the ECU 11 according to the third embodiment in accordance with corresponding program instructions stored in the storage device 12 with reference to the flowchart of FIG. 14. In particular, the ECU 11 is programmed to execute the ignition-on related routine every predetermined period during the ignition-off state of the vehicle V.

In particular, the following describes mainly operations of the ignition-on related routine illustrated in FIG. 14 different from the operations of the ignition-on related routine illustrated in FIG. 12 according to the second embodiment.

In response to determination that the network communication unit 112 has received the ignition-on signal (YES in step S131), the ignition-on related routine proceeds to step S231.

In response to determination that the personal authorization of the driver of the vehicle V has failed (FAILURE in step S231), the ignition-on related routine proceeds to step S133.

The determiner 17 of the ECU 11 according to the third embodiment described above is configured to determine not to permit (i) execution of the personal authorization application 51 as the target application 51 and (ii) power supply to the camera 20 and the illumination device 25, which are required to operate the personal authorization application 51, in response to determination that the battery information represents the recharge-required state; the recharge-required state of the battery 210 represents the amount of electrical charge in the battery 210 being lower than the predetermined electrical-charge amount.

In contrast, the determiner 17 of the ECU 11 according to the third embodiment is configured to determine to permit (i) execution of the personal authorization application 51 as the target application 51 and (ii) power supply to the camera 20 and the illumination device 25 in response to determination that the battery information does not represent the recharge-required state.

Then, the determiner 17 of the ECU 11 according to the third embodiment is configured to stop execution of the personal authorization application 51 and stop power supply to at least one of the camera 20 and the illumination device 25 after the success or failure of the personal authorization executed by the personal authorization application 51 has been finalized.

In particular, the determiner 17 of the ECU 11 according to the third embodiment is configured to determine not to permit (i) execution of the personal authorization application 51 and (ii) power supply to at least one of the camera 20 and the illumination device 25 of the information acquisition/support devices AD, which acquire information required for execution of the target application 51 and/or supports for the acquisition of the information, in response to determination that either the remaining capacity of the battery 210 is lower than the first threshold or the maximum capacity of the battery 210 is lower than the second threshold.

The determiner 17 of the ECU 11 is configured to stop execution of the personal authorization application 51 and stop power supply to at least one of the camera 20 and the illumination device 25 after the success or failure of the personal authorization executed by the personal authorization application 51 has been finalized.

Even under certain conditions where the battery 210 is in the high-charge state and charging the battery 210 is difficult, this configuration of the ECU 11 permits the personal authorization application 51 and the camera system comprised of the camera 20 and the illumination device 25 to execute the personal authorization once, and thereafter, stops the execution of the personal authorization application 51 and the power supply to at least one of the camera 20 and the illumination device 25. This therefore reduces further power consumption of the battery 210 in the ignition-off state of the vehicle V in which charging of the battery 210 is difficult.

While the illustrative embodiments of the present disclosure have been described herein, the present disclosure is not limited to the embodiments and configurations described herein. Specifically, the present disclosure can include any and all modified embodiments and modifications within the range of equivalency of the present disclosure. Additionally, various combinations of the embodiments, modified combinations to which at least one element has been added, or modified combinations from which at least one element has been eliminated are within the scope of the present disclosure and/or the patentable ideas of the present disclosure.

The vehicle control apparatuses 11 and their control methods executable by the vehicle control apparatuses in the present disclosure can be implemented by a dedicated computer including a memory and a processor programmed to perform one or more functions embodied by one or more computer programs.

The vehicle control apparatuses 11 and their control methods executable by the vehicle control apparatuses in the present disclosure can also be implemented by a dedicated computer including a processor comprised of one or more dedicated hardware logic circuits.

The vehicle control apparatuses 11 and their control methods executable by the vehicle control apparatuses in the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

The present disclosure can include the following technological aspects in addition to claims described below.

### First Technological Aspect

A startup-related determination apparatus (11) for a vehicle (V) according to the first technological aspect includes a battery-state monitor (14) configured to monitor battery information indicative of an operational state of a battery (210) installed in the vehicle when an ignition-on state of the vehicle transitions to an ignition-off state. The battery information is related to an amount of electrical charge in the battery.

The startup-related determination apparatus includes a storing unit (15) configured to store the battery information monitored by the battery-state monitor in a nonvolatile memory region (12a). The startup-related determination apparatus includes an information acquisition unit (16) configured to acquire, from the nonvolatile memory region, the battery information in response to an occurrence of a power-on startup event for the vehicle.

The startup-related determination apparatus includes a determiner (17) configured to determine, based on the battery information, whether to permit execution of a predetermined application (51) installed in the vehicle until the ignition-off state of the vehicle transitions to the ignition-on state.

### Second Technological Aspect

In the startup-related determination apparatus according to the second technological aspect, which depends from the first technological aspect, the determiner is configured to determine whether the battery information represents a recharge-required state, the recharge-required state of the battery representing the amount of the electrical charge in the battery being lower than a predetermined electrical-charge amount. The determiner is configured to determine not to permit the execution of the predetermined application installed in the vehicle in response to determination that the battery information represents the recharge-required state.

### Third Technological Aspect

In the startup-related determination apparatus according to the third technological aspect, which depends from the first technological aspect, the determiner is configured to determine whether the battery information represents a recharge-required state, the recharge-required state of the battery representing the amount of the electrical charge in the battery being lower than a predetermined electrical-charge amount. The determiner is configured to determine not to permit power supply to at least one information acquisition/support device (AD) installed in the vehicle in response to determination that the battery information represents the recharge-required state. The at least one information acquisition/support device is configured to perform at least one of (i) acquisition of the information used by the predetermined application and (ii) support of the acquisition of the information used by the predetermined application.

### Fourth Technological Aspect

In the startup-related determination apparatus according to the fourth technological aspect, which depends from the first technological aspect, the predetermined application is a personal authorization application for performing personal authorization.

The determiner is configured to determine to permit (i) execution of the personal authorization application and (ii) power supply to at least one information acquisition/support device (AD) installed in the vehicle in response to determination that the battery information represents the recharge-required state. The at least one information acquisition/support device is configured to perform at least one of (i) acquisition of the information used by the personal authorization application and (ii) support of the acquisition of the information used by the personal authorization application.

The determiner is configured to stop the execution of the personal authorization application and the power supply to the at least one information acquisition/support device after success or failure of the personal authorization of the personal authorization application has been finalized.

### Fifth Technological Aspect

In the startup-related determination apparatus according to the fifth technological aspect, which depends from the first technological aspect, the predetermined application is a personal authorization application for performing personal authorization.

The determiner is configured to determine not to permit (i) execution of the personal authorization application and (ii) power supply to at least one information acquisition/support device (AD) installed in the vehicle in response to determination that the battery information represents the recharge-required state. The at least one information acquisition/support device is configured to perform at least one of (i) acquisition of the information used by the personal authorization application and (ii) support of the acquisition of the information used by the personal authorization application.

The determiner is configured to determine to permit (i) the execution of the personal authorization application and (ii) the power supply to the at least one information acquisition/support device in response to determination that the battery information does not represent the recharge-required state.

The determiner is configured to stop the execution of the personal authorization application and the power supply to the at least one information acquisition/support device after success or failure of the personal authorization of the personal authorization application has been finalized.

### Sixth Technological Aspect

In the startup-related determination apparatus according to the sixth technological aspect, which depends from the first technological aspect, the determiner is configured to determine whether the battery information represents a recharge-required state. The recharge-required state of the battery represents the amount of the electrical charge in the battery being lower than a predetermined electrical-charge amount.

The determiner is configured to determine not to permit (i) the execution of the predetermined application installed in the vehicle and (ii) power supply to at least one information acquisition/support device (AD) installed in the vehicle in response to determination that the battery information represents the recharge-required state. The at least one information acquisition/support device is configured to perform at least one of (i) acquisition of the information used by the predetermined application and (ii) support of the acquisition of the information used by the predetermined application.

The determiner is configured to determine that the battery information represents the recharge-required state when (i) a first condition that a remaining capacity of the battery included in the battery information is lower than a predetermined first threshold is satisfied, (ii) a second condition that a maximum capacity of the battery included in the battery information is lower than a predetermined second threshold is satisfied, (iii) a third condition that a rated capacity of the battery included in the battery information is lower than a predetermined third threshold is satisfied, or any combination of the first to third conditions is satisfied.

### Seventh Technological Aspect

In the startup-related determination apparatus according to the seventh technological aspect, which depends from any one of the first to sixth technological aspects, the determiner is configured to permit the execution of the predetermined application and power supply to at least one information acquisition/support device installed in the vehicle in response to when the ignition-state of the vehicle transitions to the ignition-on state, the at least one information acquisition/support device being configured to perform at least one of (i) acquisition of the information used by the predetermined application and (ii) support of the acquisition of the information used by the predetermined application.

### Eighth Technological Aspect

In the startup-related determination apparatus according to the seventh technological aspect, which depends from any one of the first to seventh technological aspects, the power-on startup event is an opening of a door of the vehicle.

### Ninth Technological Aspect

In the startup-related determination apparatus according to the ninth technological aspect, which depends from any one of the fourth and fifth technological aspects, the nonvolatile memory region stores registered images, each of which includes a face of at least one of registered users. The at least one information acquisition/support device includes a camera that is activated based on the power supply to capture an image of a driver of the vehicle, the image including a face of the driver. The personal authorization application causes a processor (11a) to
(I) Recognize, based on the image, the face of the driver
(II) Retrieve, from the nonvolatile memory region, the registered images
(III) Match the recognized face of the driver against the registered images to calculate a matching score between the recognized face of the driver and each of the registered images
(IV) Determine whether each matching score is lower than a predetermined threshold
(V) Determine that personal authorization of the driver is successful in response to determination that the matching score of the recognized face of the driver with at least one of the registered images is higher than or equal to the predetermined matching threshold.

### Tenth Technological Aspect

In the startup-related determination apparatus according to the tenth technological aspect, which depends from the ninth technological aspect, the startup-related determination apparatus is configured to adjust, in response to determination that the personal authorization of the driver is successful, in-cabin environment settings of the vehicle to predetermined respective settings associated with the authenticated driver of the vehicle.

### Eleventh Technological Concept

A startup-related determination method for a vehicle (V) according to the eleventh technological concept includes monitoring battery information indicative of an operational state of a battery (210) installed in the vehicle when an ignition-on state of the vehicle transitions to an ignition-off state. The battery information is related to an amount of electrical charge in the battery.

The startup-related determination method includes storing the battery information in a nonvolatile memory region (12a).

The startup-related determination method includes acquiring, from the nonvolatile memory region, the battery information in response to an occurrence of a power-on startup event for the vehicle.

The startup-related determination method includes determining, based on the battery information, whether to permit execution of a predetermined application installed in the vehicle until the ignition-off state of the vehicle transitions to the ignition-on state.

### Twelfth Technological Concept

A program product for a vehicle (V) according to the twelfth technological concept includes a non-transitory storage media (12) and program instructions stored in the non-transitory storage media. The program instructions cause a processor (11a) to
(I) Monitor battery information indicative of an operational state of a battery (210) installed in the vehicle when an ignition-on state of the vehicle transitions to an ignition-off state, the battery information being related to an amount of electrical charge in the battery
(II) Store the battery information monitored by the battery-state monitor in a nonvolatile memory region (12a)
(III) Acquire, from the nonvolatile memory region, the battery Information in response to an occurrence of a power-on startup event for the vehicle
(IV) Determine, based on the battery information, whether to permit execution of a predetermined application installed in the vehicle until the ignition-off state of the vehicle transitions to the ignition-on state

1. A startup-related determination apparatus for a vehicle, the startup-related determination apparatus comprising:
a battery-state monitor configured to monitor battery information indicative of an operational state of a battery installed in the vehicle when an ignition-on state of the vehicle transitions to an ignition-off state, the battery information being related to an amount of electrical charge in the battery;
a storing unit configured to store the battery information monitored by the battery-state monitor in a nonvolatile memory region;
an information acquisition unit configured to acquire, from the nonvolatile memory region, the battery information in response to an occurrence of a power-on startup event for the vehicle; and
a determiner configured to determine, based on the battery information, whether to permit execution of a predetermined application installed in the vehicle until the ignition-off state of the vehicle transitions to the ignition-on state.

2. The startup-related determination apparatus according to claim 1, wherein:
the determiner is configured to:
determine whether the battery information represents a recharge-required state, the recharge-required state of the battery representing the amount of the electrical charge in the battery being lower than a predetermined electrical-charge amount; and
determine not to permit the execution of the predetermined application installed in the vehicle in response to determination that the battery information represents the recharge-required state.

3. The startup-related determination apparatus according to claim 1, wherein:
the determiner is configured to:
determine whether the battery information represents a recharge-required state, the recharge-required state of the battery representing the amount of the electrical charge in the battery being lower than a predetermined electrical-charge amount; and
determine not to permit power supply to at least one information acquisition/support device installed in the vehicle in response to determination that the battery information represents the recharge-required state, the least at one information acquisition/support device being configured to perform at least one of (i) acquisition of the information used by the predetermined application and (ii) support of the acquisition of the information used by the predetermined application.

4. The startup-related determination apparatus according to claim 1, wherein:
the predetermined application is a personal authorization application for performing personal authorization;
the determiner is configured to:
determine to permit (i) execution of the personal authorization application and (ii) power supply to at least one information acquisition/support device installed in the vehicle in response to determination that the battery information represents the recharge-required state, the at least one information acquisition/support device being configured to perform at least one of (i) acquisition of the information used by the personal authorization application and (ii) support of the acquisition of the information used by the personal authorization application; and
stop the execution of the personal authorization application and the power supply to the at least one information acquisition/support device after success or failure of the personal authorization of the personal authorization application has been finalized.

5. The startup-related determination apparatus according to claim 1, wherein:
the predetermined application is a personal authorization application for performing personal authorization;
the determiner is configured to:
determine not to permit (i) execution of the personal authorization application and (ii) power supply to at least one information acquisition/support device installed in the vehicle in response to determination that the battery information represents the recharge-required state, the at least one information acquisition/support device being configured to perform at least one of (i) acquisition of the information used by the personal authorization application and (ii) support of the acquisition of the information used by the personal authorization application;
determine to permit (i) the execution of the personal authorization application and (ii) the power supply to the at least one information acquisition/support device in response to determination that the battery information does not represent the recharge-required state; and
stop the execution of the personal authorization application and the power supply to the at least one information acquisition/support device after success or failure of the personal authorization of the personal authorization application has been finalized.

6. The startup-related determination apparatus according to claim 1, wherein:
the determiner is configured to:
determine whether the battery information represents a recharge-required state, the recharge-required state of the battery representing the amount of the electrical charge in the battery being lower than a predetermined electrical-charge amount; and
determine not to permit (i) the execution of the predetermined application installed in the vehicle and (ii) power supply to at least one information acquisition/support device installed in the vehicle in response to determination that the battery information represents the recharge-required state, the at least one information acquisition/support device being configured to perform at least one of (i) acquisition of the information used by the predetermined application and (ii) support of the acquisition of the information used by the predetermined application; and
the determiner is configured to determine that the battery information represents the recharge-required state when (i) a first condition that a remaining capacity of the battery included in the battery information is lower than a predetermined first threshold is satisfied, (ii) a second condition that a maximum capacity of the battery included in the battery information is lower than a predetermined second threshold is satisfied, (iii) a third condition that a rated capacity of the battery included in the battery information is lower than a predetermined third threshold is satisfied, or any combination of the first to third conditions is satisfied.

7. The startup-related determination apparatus according to claim 1, wherein:
the determiner is configured to permit the execution of the predetermined application and power supply to at least one information acquisition/support device installed in the vehicle in response to when the ignition-state of the vehicle transitions to the ignition-on state, the at least one information acquisition/support device being configured to perform at least one of (i) acquisition of the information used by the predetermined application and (ii) support of the acquisition of the information used by the predetermined application.

8. The startup-related determination apparatus according to claim 1, wherein:
the power-on startup event is an opening of a door of the vehicle.

9. The startup-related determination apparatus according to claim 4, wherein:
the nonvolatile memory region stores registered images, each of which includes a face of at least one of registered users;
the at least one information acquisition/support device includes a camera that is activated based on the power supply to capture an image of a driver of the vehicle, the image including a face of the driver;
the personal authorization application causes a processor to:
recognize, based on the image, the face of the driver;
retrieve, from the nonvolatile memory region, the registered images;
match the recognized face of the driver against the registered images to calculate a matching score between the recognized face of the driver and each of the registered images;
determine whether each matching score is lower than a predetermined threshold; and
determine that personal authorization of the driver is successful in response to determination that the matching score of the recognized face of the driver with at least one of the registered images is higher than or equal to the predetermined matching threshold.

10. The startup-related determination apparatus according to claim 9, wherein:
the startup-related determination apparatus is configured to adjust, in response to determination that the personal authorization of the driver is successful, in-cabin environment settings of the vehicle to predetermined respective settings associated with the authenticated driver of the vehicle.

11. A startup-related determination method for a vehicle, the startup-related determination method comprising:
monitoring battery information indicative of an operational state of a battery installed in the vehicle when an ignition-on state of the vehicle transitions to an ignition-off state, the battery information being related to an amount of electrical charge in the battery;
storing the battery information in a nonvolatile memory region;
acquiring, from the nonvolatile memory region, the battery information in response to an occurrence of a power-on startup event for the vehicle; and
determining, based on the battery information, whether to permit execution of a predetermined application installed in the vehicle until the ignition-off state of the vehicle transitions to the ignition-on state.

12. A program product for a vehicle, the program product comprising:
a non-transitory storage media; and
program instructions stored in the non-transitory storage media, the program instructions causing a processor to:
monitor battery information indicative of an operational state of a battery installed in the vehicle when an ignition-on state of the vehicle transitions to an ignition-off state, the battery information being related to an amount of electrical charge in the battery;
store the battery information monitored by the battery-state monitor in a nonvolatile memory region;
acquire, from the nonvolatile memory region, the battery information in response to an occurrence of a power-on startup event for the vehicle; and
determine, based on the battery information, whether to permit execution of a predetermined application installed in the vehicle until the ignition-off state of the vehicle transitions to the ignition-on state.
